(19) United States
(12) Patent Application Publication
(10) Pub. No.: US 2025/0057220 A1
(43) Pub. Date: Feb. 20, 2025

(54) AEROSOL-GENERATING SYSTEM

(71) Applicant: Japan Tobacco Inc., Tokyo (JP)

(72) Inventor: Hitoshi TAMBO, Tokyo (JP)

(73) Assignee: Japan Tobacco Inc., Tokyo (JP)

(21) Appl. No.: 18/939,583

(22) Filed: Nov. 7, 2024

Related U.S. Application Data
(63) Continuation of application No. PCT/JP2022/020809, filed on May 19, 2022.

(51) Int. Cl. A24F 40/40; A24D 1/20; A24F 40/20; A24F 40/46

(52) U.S. Cl. CPC A24F 40/40; A24D 1/20; A24F 40/20; A24F 40/46

(57) ABSTRACT

This aerosol-generating system comprises: an aerosol-generating device; an aerosol-generating article that generates an aerosol by heating; and a heating unit, wherein the aerosol-generating device includes a receptacle that houses the aerosol-generating article, and a power supply unit that supplies power to the heating unit, the heating unit heats the aerosol-generating article housed in the receptacle, a first shaped portion having a protruding first shape is formed on the bottom of the receptacle, the aerosol-generating article has an end portion inserted into the receptacle, the end portion is configured to include a second shaped portion having a second shape corresponding to the first shape when the aerosol-generating article is housed in the receptacle, and at least a part of a surface of the second shaped portion is inclined with respect to the longitudinal direction of the aerosol-generating article.

### CROSS-REFERENCE TO RELATED APPLICATION

The present invention contains subject matter related to PCT Application No. PCT/JP2022/020809 filed on May 19, 2022, the entire contents of which are incorporated herein by reference.

### TECHNICAL FIELD

The present invention relates to an aerosol-generating system.

### BACKGROUND ART

Conventionally, an aerosol-generating device that generates an aerosol by heating a material without burning the material to inhale a flavor or the like is known. The aerosol-generating device and an aerosol-generating article containing this material constitute an aerosol-generating system. In the aerosol-generating device, various structures have been proposed for a receptacle that houses the material. According to Patent Literature 1, in the aerosol-generating device that heats a material from outside the material, when the material is inserted into a cavity, only a plurality of protrusions is configured to contact the material, thereby inhibiting heat loss from the material. In Patent Literature 2, a recess is defined by an inner surface of a heating chamber to facilitate cleaning of the heating chamber.

### CITATION LIST

### Patent Literature

PTL 1: International Publication No. WO 2020/216762
PTL 2: Japanese Translation of PCT International Application Publication No. 2021-508243
PTL 3: Japanese Translation of PCT International Application Publication No. 2021-502800

### SUMMARY OF INVENTION

### Technical Problem

When a user of an aerosol-generating device (hereinafter referred to simply as the user) takes an aerosol-generating article out of a receptacle after heating of the aerosol-generating article, a part of the aerosol-generating article sticks to a heating unit or an inner surface of the receptacle and may not be removed. To solve this problem, Patent Literature 3 proposes an aerosol-generating device including a rotation unit in which an aerosol-forming substrate and a heating body can move relative to each other in a circumferential direction. The aerosol-generating device of Patent Literature 3 has problems such as increased complexity or size of the aerosol-generating device.

One of objects of the present invention is to provide an aerosol-generating system that inhibits contents of an aerosol-generating article from remaining in a receptacle, when the aerosol-generating article is taken out of the receptacle, while inhibiting complexity or size of an aerosol-generating device from increasing.

### Solution to Problem

According to a first aspect, an aerosol-generating system is provided. The aerosol-generating system comprises an aerosol-generating device, an aerosol-generating article that generates an aerosol by heating, and a heating unit, wherein the aerosol-generating device comprises a receptacle that houses the aerosol-generating article, and a power supply unit that supplies power to the heating unit, the heating unit heats the aerosol-generating article housed in the receptacle, a first shaped portion having a protruding first shape is formed on a bottom of the receptacle, the aerosol-generating article comprises an end portion inserted into the receptacle, the end portion is configured to include a second shaped portion having a second shape corresponding to the first shape, when the aerosol-generating article is housed in the receptacle, and at least part of a surface of the second shaped portion is inclined with respect to a longitudinal direction of the aerosol-generating article.

According to the first aspect, while inhibiting the complexity or size of the aerosol-generating device from increasing, the second shape corresponding to the protruding first shape can inhibit the contents of the aerosol-generating article from remaining in the receptacle, when the aerosol-generating article is taken out of the receptacle. This can reduce the need for maintenance such as cleaning. Furthermore, reduction of heating efficiency can be inhibited by inhibiting the aerosol-generating article from adhering to the heating unit.

A second aspect is that in the first aspect, the second shaped portion holds contents of the aerosol-generating article so that the contents do not remain in the receptacle, when the aerosol-generating article is taken out of the receptacle.

According to the second aspect, when the aerosol-generating article is taken out of the receptacle, the contents of the aerosol-generating article, held by the second shaped portion, can be more securely inhibited from remaining in the receptacle.

A third aspect is that in the first or second aspect, a packaging material packaging the aerosol-generating article forms the surface of the second shaped portion.

According to the third aspect, it is possible to provide the aerosol-generating system efficiently having effects of the above aspects at reduced cost.

A fourth aspect is that in the third aspect, the packaging material has a basis weight of 20 gsm or more and 200 gsm or less.

According to the fourth aspect, when the aerosol-generating article is taken out of the receptacle, the contents of the aerosol-generating article can be firmly held by the packaging material to inhibit the contents from remaining in the receptacle, and an adverse effect due to an excessive amount of packaging material, such as difficulty in forming the second shaped portion, can be inhibited.

A fifth aspect is that in the third or fourth aspect, the second shaped portion comprises a fold of the packaging material toward inside the end portion.

According to the fifth aspect, when the aerosol-generating article is taken out of the receptacle, it is possible to further securely inhibit the contents of the aerosol-generating article from remaining in the receptacle. Furthermore, the aerosol-generating article having such an effect can be easily formed by folding the packaging material.

A sixth aspect is that in any of the first to fifth aspects, at least part of the surface of the second shaped portion is inclined with respect to a direction to insert the aerosol-generating article into the receptacle so that a tangent plane of the at least part of the surface of the second shaped portion intersects a central axis of the aerosol-generating article on an end face side of the end portion away from the at least part of the surface of the second shaped portion.

According to the sixth aspect, the contents of the aerosol-generating article, held by the surface inclined with respect to the inserting direction, can be more securely inhibited from remaining in the receptacle, when the aerosol-generating article is taken out of the receptacle.

A seventh aspect is that in any of the first to sixth aspects, a width of the second shape in a certain direction perpendicular to the longitudinal direction of the aerosol-generating article increases as being toward an end face side of the end portion of the aerosol-generating article.

According to the seventh aspect, for a wider range of contents in the aerosol-generating article, it is possible to inhibit the contents from remaining in the receptacle, when the aerosol-generating article is taken out of the receptacle.

An eighth aspect is that in any of the first to seventh aspects, the second shaped portion is disposed on each of opposite sides of the end portion along a direction perpendicular to the longitudinal direction of the aerosol-generating article.

According to the eighth aspect, when the aerosol-generating article is taken out of the receptacle, the second shaped portion holds the contents on each of the opposite sides of the end portion of the aerosol-generating article and can more securely inhibit the contents from remaining in the receptacle.

A ninth aspect is that in the first to eighth aspects, the first shape has an arched shape.

As will be described later, in the aerosol-generating article, a side on which the end portion to be first inserted into the aerosol-generating device is disposed is an upstream side, and a side opposite to the upstream side is a downstream side. According to the ninth aspect, the side surface of the aerosol-generating article is biased downstream while being biased inward by an arched inclined surface. When the aerosol-generating article is taken out of the receptacle, the contents of the aerosol-generating article are firmly held by a biased portion, and the contents can be inhibited from remaining in the receptacle.

A tenth aspect is that in any of the first to ninth aspects, the first shape has a blade shape.

When a wide surface abuts on the end portion of the aerosol-generating article, the contents of the aerosol-generating article move in a direction intersecting a pressing direction, and the end portion of the aerosol-generating article expands. According to the tenth aspect, on biasing the end portion of the aerosol-generating article by the blade-shaped first shaped portion, the end portion is less likely to expand as compared with a case where the end portion is biased by the wide surface. Therefore, when the aerosol-generating article is taken out of the receptacle, the contents of the aerosol-generating article are even less likely to remain in the receptacle.

An eleventh aspect is that in any of the first to tenth aspects, the receptacle comprises a bottom wall intersecting a receptacle central axis that is a central axis of the receptacle, and a side wall extending along the receptacle central axis, and the first shaped portion is provided in contact with at least one of the bottom wall and the side wall.

According to the eleventh aspect, a user does not have to perform a complicated operation when housing the aerosol-generating article in the receptacle, and the first shaped portion formed on the bottom wall or the side wall can form the second shaped portion.

A twelfth aspect is that in the eleventh aspect, a surface of the first shaped portion is inclined with respect to the receptacle central axis.

According to the twelfth aspect, since the end portion of the aerosol-generating article can be biased toward inside the aerosol-generating article by the inclined surface, the contents of the aerosol-generating article are even less likely to remain in the receptacle when the article is taken out of the receptacle.

A thirteenth aspect is that in the twelfth aspect, in a certain vertical cross section including the receptacle central axis, an angle formed by the surface of the first shaped portion and the receptacle central axis is 30° or more and 60° or less.

According to the thirteenth aspect, when inserting the aerosol-generating article into the receptacle, the aerosol-generating article can be biased inward while facilitating formation of a folded portion.

A fourteenth aspect is that in the eleventh to thirteenth aspects, the first shape includes a sharp shape extending along a radial direction with respect to the receptacle central axis and tapering toward the receptacle central axis.

According to the fourteenth aspect, the first shaped portion can bias the aerosol-generating article in the radial direction toward the receptacle central axis without expanding the end portion of the aerosol-generating article. When the aerosol-generating article is taken out of the receptacle, the contents are even less likely to remain in the receptacle.

A fifteenth aspect is that in any of the eleventh to fourteenth aspects, a width of the first shape in a direction perpendicular to the receptacle central axis gradually decreases or increases along the receptacle central axis.

According to the fifteenth aspect, damages on the aerosol-generating article that abuts on the first shaped portion can be reduced because the first shape does not change rapidly.

A sixteenth aspect is that in any of the eleventh to fifteenth aspects, the receptacle includes a plurality of first shaped portions provided at different circumferential positions with respect to the receptacle central axis.

According to the sixteenth aspect, when the aerosol-generating article is housed in the receptacle, a plurality of second shaped portions corresponding to the plurality of first shaped portions is present in the aerosol-generating article. When the aerosol-generating article is taken out of the receptacle, the contents are even less likely to remain in the receptacle.

A seventeenth aspect is that in any of the first to sixteenth aspects, the receptacle comprises the heating unit, or a metal body housed in the receptacle together with the aerosol-generating article constitutes a heating element of the heating unit.

According to the seventeenth aspect, the heating unit can be flexibly designed.

An eighteenth aspect is that in the seventeenth aspect, the receptacle comprises the heating unit, and the heating unit comprises a plate-shaped heater.

According to the eighteenth aspect, insertion of the heating unit into the aerosol-generating article can be facilitated. Furthermore, when the first shaped portion is formed along a width direction of the plate-shaped heater, folding of the end portion of the aerosol-generating article can be facilitated.

A nineteenth aspect is that in the eighteenth aspect, the first shaped portion is disposed along a direction in which the plate-shaped heater extends in the bottom of the receptacle.

According to the nineteenth aspect, since a distance between the first shaped portion and the heating unit can be shorter, the end portion of the aerosol-generating article housed in the receptacle can be biased to a position close to the heating unit. When the aerosol-generating article is taken out of the receptacle, the contents are less likely to remain in the receptacle with more certainty. In addition, a compact aerosol-generating device can be provided, for example, by reducing a thickness direction of the plate-shaped heater.

A twentieth aspect is that in any of the seventeenth to nineteenth aspects, the receptacle comprises the heating unit, and the heating unit comprises a PTC heater.

According to the twentieth aspect, by utilizing PTC characteristics, a temperature of the heating unit can be kept at or below a certain temperature without the need for a control device or the like that stops heating when the temperature reaches or exceeds a predetermined temperature.

A twenty-first aspect is that in any of the seventeenth to twentieth aspects, the heating unit is configured to heat the aerosol-generating article from inside, when the aerosol-generating article is housed in the aerosol-generating device.

According to the twenty-first aspect, the aerosol-generating article can be efficiently heated.

A twenty-second aspect is that in any of the seventeenth to twenty-first aspects, the aerosol-generating system further comprises, on a side wall of the receptacle, a biasing portion that biases the aerosol-generating article toward the heating unit when the aerosol-generating article is housed in the aerosol-generating device.

According to the twenty-second aspect, since the aerosol-generating article, biased by the biasing portion, can be in close contact with the heating unit, heat transfer efficiency can improve, and the aerosol-generating article can be prevented from falling out.

A twenty-third aspect is that in the twenty-second aspect, the receptacle comprises the heating unit, the heating unit comprises a plate-shaped heater, the plate-shaped heater comprises a first main surface perpendicular to a thickness direction and a second main surface formed on a back side of the first main surface, and the biasing portion is disposed opposite to at least one of the first main surface and the second main surface of the plate-shaped heater in the side wall of the receptacle.

According to the twenty-third aspect, the contents of the aerosol-generating article move in a direction intersecting a direction in which the first shaped portion presses, and the end portion of the aerosol-generating article can be inhibited from expanding by the biasing portion, so that when the aerosol-generating article is taken out of the receptacle, the contents are even less likely to remain in the receptacle.

A twenty-fourth aspect is that in any of the first to twenty-third aspect, the end portion of the aerosol-generating article does not comprise the second shaped portion, and the end portion and the first shaped portion are configured such that the end portion is pressed by the first shaped portion to form the second shaped portion, when the aerosol-generating article is inserted into the receptacle.

According to the twenty-fourth aspect, it is not necessary to process the second shaped portion in advance on the aerosol-generating article, and when the aerosol-generating article is taken out of the receptacle, the contents of the aerosol-generating article can be inhibited from remaining in the receptacle.

A twenty-fifth aspect is that in any of the first to twenty-third aspect, the end portion of the aerosol-generating article comprises the second shaped portion.

According to the twenty-fifth aspect, since the second shaped portion is formed in advance, the contents of the aerosol-generating article can be further securely inhibited from remaining in the receptacle, when the aerosol-generating article is taken out of the receptacle.

A twenty-sixth aspect is that in the twenty-fifth aspect, at least one of the aerosol-generating article and the aerosol-generating device comprises a marker for inserting the aerosol-generating article so that the first shaped portion is opposite to the second shaped portion.

According to the twenty-sixth aspect, it is possible to inhibit an adverse effect such as reduced heating efficiency due to the first shaped portion and the second shaped portion being arranged at unintended relative positions.

A twenty-seventh aspect is that in any of the first to twenty-sixth aspects, the first shape includes a convex portion, and the second shape includes a concave portion.

According to the twenty-seventh aspect, the end portion of the aerosol-generating article can be easily deformed in abutment on the convex portion, and the concave portion obtained by the deformation can inhibit the contents from remaining in the receptacle, when the aerosol-generating article is taken out of the receptacle.

A twenty-eighth aspect is that in any of the first to twenty-seventh aspects, the aerosol-generating device is a flavor inhaler that generates an aerosol having a flavor, and the aerosol-generating article is a tobacco stick.

According to the twenty-eighth aspect, when taking the tobacco stick out of a receptacle of the flavor inhaler, contents of the tobacco stick can be inhibited from remaining in the receptacle. Consequently, need for maintenance such as cleaning of the flavor inhaler can be reduced. Furthermore, reduction of heating efficiency during tobacco smoking can be inhibited by inhibiting the aerosol-generating article from sticking to the heating unit.

### BRIEF DESCRIPTION OF DRAWINGS

FIG. 1 is a cross-sectional view showing a main part of an aerosol-generating system according to a first embodiment in a width direction of a heating unit.

FIG. 2 is a cross-sectional view showing a main part of an aerosol-generating device according to the first embodiment in the width direction of the heating unit.

FIG. 3 is a cross-sectional view showing the main part of the aerosol-generating device according to the first embodiment in a thickness direction of the heating unit.

FIG. 4 is a cross-sectional view on arrows A-A of FIG. 3.

FIG. 5 is a perspective view schematically showing a heating control system according to the first embodiment.

FIG. 6A is a schematic cross-sectional side view showing an aerosol-generating article according to the first embodiment.

FIG. 6B is a conceptual view showing a cross section of a tobacco part orthogonal to a longitudinal direction of the aerosol-generating article shown in FIG. 6A.

FIG. 7 is a schematic side view showing the aerosol-generating article housed in a receptacle.

FIG. 8 is a schematic side view showing the aerosol-generating article housed in the receptacle.

FIG. 9 is a cross-sectional view showing a housed state of the aerosol-generating article in an aerosol-generating device.

FIG. 10 is a cross-sectional view showing a housed state of the aerosol-generating article in the aerosol-generating device.

FIG. 11 is a cross-sectional view showing a housed state of the aerosol-generating article in the aerosol-generating device.

FIG. 12 is a cross-sectional view showing a main part of an aerosol-generating device according to Modification 1-1 in a width direction of a heating unit.

FIG. 13 is a cross-sectional view showing a main part of an aerosol-generating device according to Modification 1-2 in a width direction of a heating unit.

FIG. 14 is a vertical cross-sectional view showing a main part of an aerosol-generating device according to Modification 1-3.

FIG. 15 is a cross-sectional view on arrows D-D of FIG. 14.

FIG. 16 is a schematic view showing an aerosol-generating system according to a second embodiment.

FIG. 17 is a side view of an aerosol-generating article on arrows F-F of FIG. 16.

FIG. 18 is a cross-sectional view on arrows G-G of FIG. 16.

FIG. 19 is a schematic cross-sectional side view of an aerosol-generating article according to Modification 2-1.

FIG. 20 is a cross-sectional view on arrows H-H of FIG. 19.

FIG. 21 is a schematic side view showing an aerosol-generating article according to Modification 2-2.

FIG. 22 is a schematic cross-sectional view showing a wrapper of an aerosol-generating article according to Modification 2-3.

### DESCRIPTION OF EMBODIMENTS

Hereinafter, embodiments of the present invention will be described with reference to the drawings. In the drawings described below, the same or corresponding components are denoted with the same reference signs and duplicate descriptions are omitted. In the following embodiments, a tobacco stick will be described as an example of an aerosol-generating article, and the aerosol-generating article is not limited to tobacco if an aerosol is generated by heating.

### First Embodiment

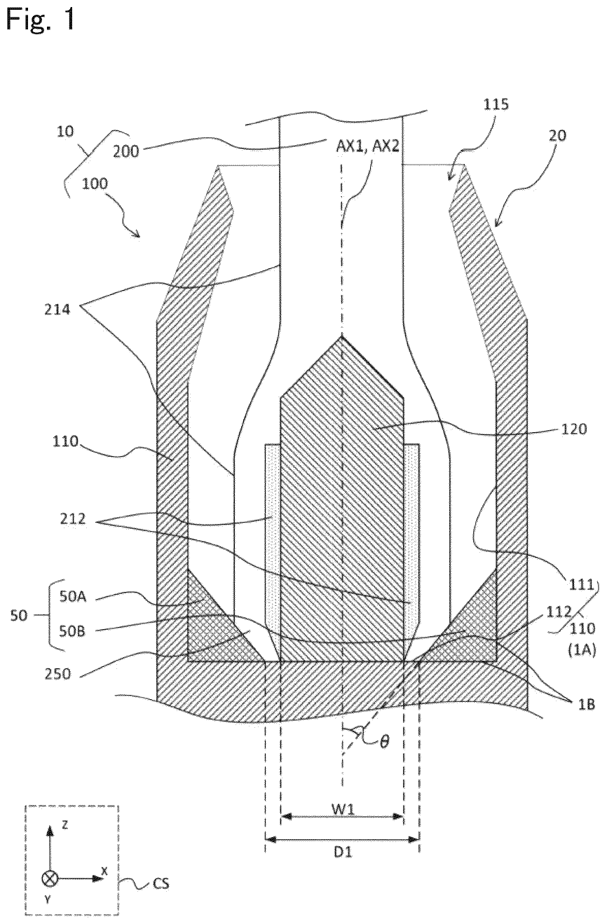

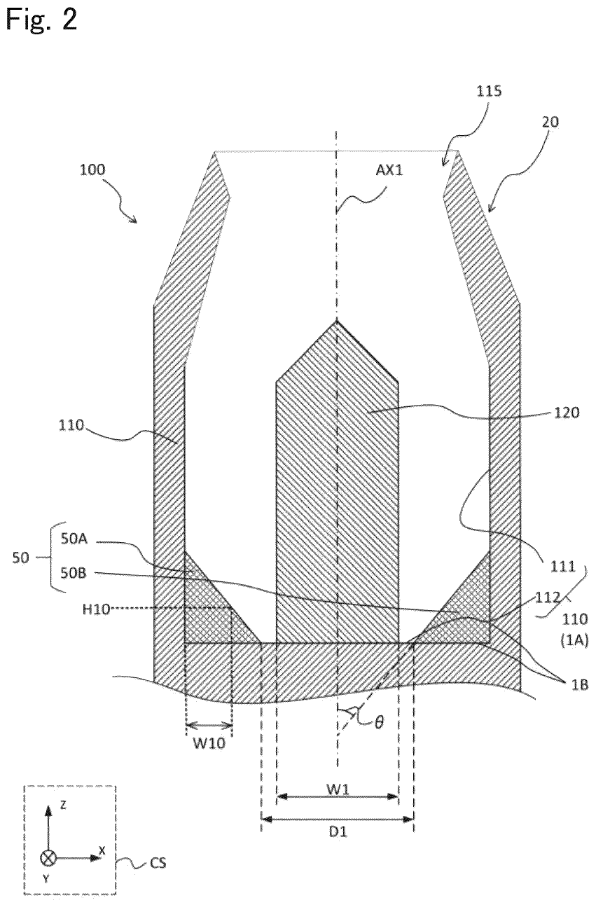

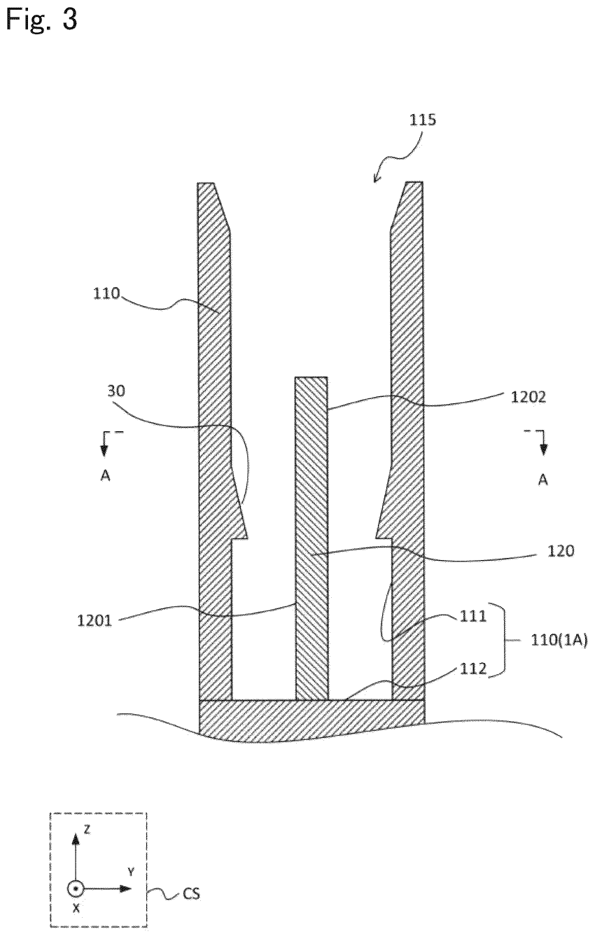

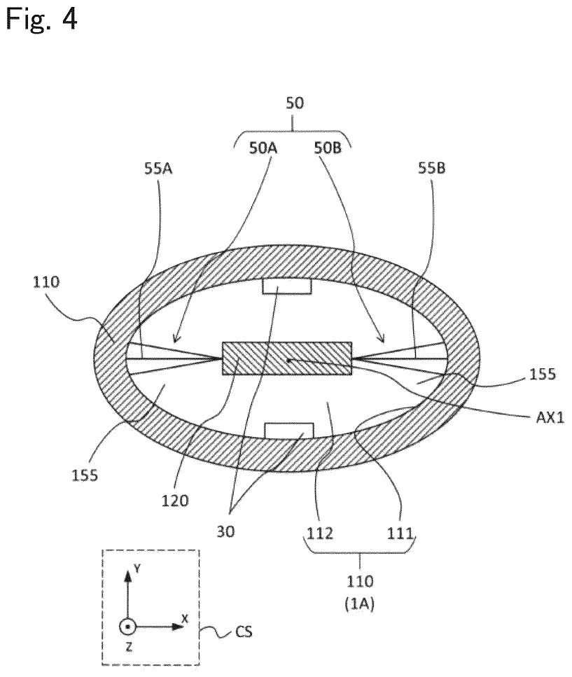

FIG. 1 is a cross-sectional view showing a main part of an aerosol-generating system 10 according to a first embodiment of the present invention in a width direction of a heating unit 120. FIG. 2 is a cross-sectional view showing a main part of an aerosol-generating device 100 constituting the aerosol-generating system 10 in the width direction of the heating unit 120. FIG. 3 is a cross-sectional view showing the main part of the aerosol-generating device 100 in a thickness direction of the heating unit 120. FIG. 4 is a cross-sectional view on arrows A-A of FIG. 3. The aerosol-generating system 10 comprises the aerosol-generating device 100 and an aerosol-generating article 200. The aerosol-generating device 100 functions as a flavor inhaler that heats the aerosol-generating article 200 as a consumable material containing a flavor-generating substrate, without burning the material, and that generates an aerosol having a flavor. FIG. 1 shows a housed state of the aerosol-generating article 200 in the aerosol-generating device 100. Usually, a user is provided with the aerosol-generating device 100, and the aerosol-generating article 200 that is not housed in the aerosol-generating device 100, and the user houses the aerosol-generating article 200 in the aerosol-generating device 100 to perform inhalation.

Hereinafter, a direction perpendicular to a plane on which the plate-shaped heating unit 120 extends is referred to as the thickness direction, and a direction perpendicular to the thickness direction and a longitudinal direction of the heating unit 120 is referred to as the width direction. Unless otherwise specified, an X-axis is parallel to the width direction, a Y-axis is parallel to the thickness direction, and a Z-axis is parallel to the longitudinal direction of the heating unit 120 (see a coordinate system CS).

The aerosol-generating device 100 comprises a housing 110 and the heating unit 120. The housing 110 functions as a receptacle 1A having an opening 115 at one end and housing at least part of the aerosol-generating article 200 inserted into the housing 110 via the opening 115. The housing 110 comprises a side wall 111 and a bottom wall 112. Hereinafter, the bottom wall 112 and a part of the side wall 111 at a position opposite to an upstream end portion 250 described later of the aerosol-generating article 200 housed in the receptacle 1A are appropriately referred to as a bottom 1B of the receptacle 1A. A central axis of the receptacle 1A constituted by the housing 110 is referred to as a first central axis AX1. The first central axis AX1 extends along the longitudinal direction of the housing 110. The side wall 111 extends along the first central axis AX1, and in the illustrated example, the side wall 111 is cylindrical about an axis of the first central axis AX1. The bottom wall 112 extends in a direction intersecting the first central axis AX1, and in the illustrated example, the bottom wall is substantially perpendicular to the first central axis AX1. In the following, a radial or circumferential direction refers to the circumferential direction and the radial direction in a rotating coordinate system about the axis of the first central axis AX1. In a housed state of the aerosol-generating article 200 in the housing 110, the first central axis AX1 may be superimposed on a second central axis AX2, which is a central axis of the aerosol-generating article 200. Note that in the present embodiment, a case where an outer wall of the housing 110 and a side wall of the receptacle 1A are integrated will be described as an example, and the receptacle 1A having the side wall and the bottom wall may be provided at any position of an interior of the housing 110.

The housing 110 is made of, for example, a resin. Particularly, the housing may be made of polycarbonate (PC), acrylonitrile-butadiene-styrene (ABS) resin, polyetheretherketone (PEEK), a polymer alloy containing a plurality of types of polymers, or the like. Alternatively, the housing 110 may be formed of a metal such as aluminum. In the illustrated example, the housing 110 is configured such that a cross-sectional area in a cross section of the housing 110 orthogonal to the longitudinal direction of the housing 110 is smallest in the vicinity of the opening 115 and this is not restrictive.

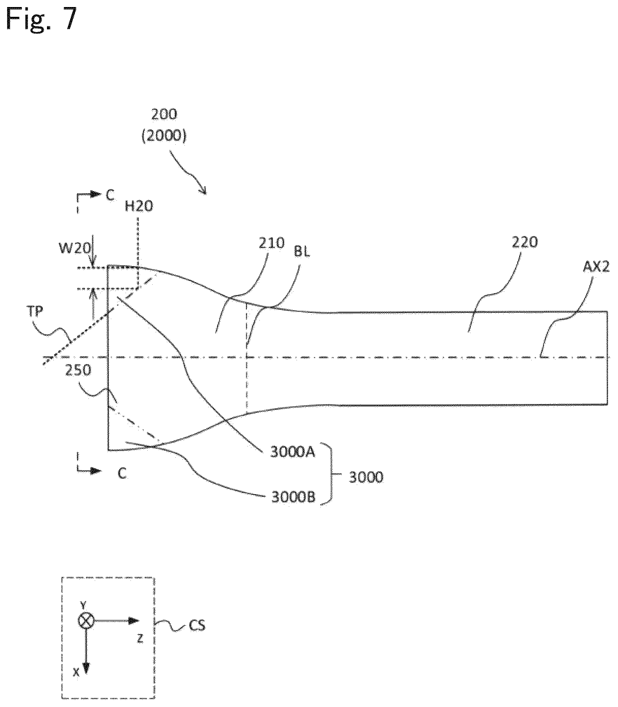

Furthermore, the housing 110 has a shaping guide (guide unit) 20, a pressing rib 30, and first shaped portions 50A and 50B. The shaping guide 20 forms the opening 115 and deforms a cross-sectional shape of the aerosol-generating article 200 inserted into the housing 110 in correspondence with a shape of the heating unit 120. The pressing rib 30 is provided on an inner peripheral surface of the side wall 111 of the housing 110 and functions as a biasing portion for biasing the aerosol-generating article 200 inserted into the housing 110 toward the heating unit 120 and deforms the aerosol-generating article 200. If such biasing can be performed, a shape of the biasing portion is not limited to an illustrated shape. In the present embodiment, the first shaped portions 50A and 50B form a second shaped portion 3000 (FIG. 7) described later, and the second shaped portion 3000 inhibits contents of the aerosol-generating article 200 from remaining in the receptacle 1A, when the aerosol-generating article 200 is taken out of the receptacle 1A. This respect will be described in detail later. Note that if the aerosol-generating article 200 can be fixed to the heating unit 120 with desired accuracy, the shaping guide 20 and the pressing rib 30 may not be provided.

Also, an intake hole (not shown in the figure) is provided in the bottom wall 112 formed on a side opposite to the opening 115 of the housing 110. By supplying air to the aerosol-generating article 200 housed in the housing 110 via this intake hole, the aerosol-generating device 100 constitutes a bottom flow type flavor inhaler. By providing the intake hole on the side opposite to the opening 115 of the housing 110, a configuration in the vicinity of the opening 115 of the housing 110 can be simplified.

The heating unit 120 heats the aerosol-generating article 200. In the present embodiment, the heating unit 120 is inserted into the aerosol-generating article 200 housed in the housing 110, to heat the aerosol-generating article 200 from inside. This can efficiently heat the aerosol-generating article 200. The heating unit 120 is preferably a plate-shaped heater. The plate-shaped heater facilitates the insertion of the heating unit 120 into the aerosol-generating article 200. Furthermore, as will be described later, the first shaped portions 50A and 50B are formed along the width direction of the plate-shaped heater, to facilitate folding of the upstream end portion 250 of the aerosol-generating article 200 and formation of the second shaped portion 3000.

The heating unit 120 comprises a resistive heating element (not shown in the figure) located in the interior of the housing 110 and can be configured to generate heat by applying a voltage to the resistive heating element. The heating unit 120 is preferably a positive temperature coefficient (PTC) heater. From viewpoint of improving heating efficiency, the heating unit 120 is more preferably a plate-shaped PTC heater. Furthermore, the heating unit 120 deforms an outer shape of the aerosol-generating article 200 inserted into the housing 110 along the shape of the heating unit 120.

The PTC heater is a heater using a resistor having characteristics that at a certain temperature (referred to as the Curie temperature), electrical resistance increases rapidly, and electricity stops flowing (PTC characteristics). By utilizing the PTC characteristics, the PTC heater can keep the temperature at or below a certain temperature without the need for a control device or the like that stops heating when the temperature reaches or exceeds a predetermined temperature. The heating unit 120 may be a PTC heater using barium titanate (BaTiO₃) having the PTC characteristics as a resistor. In such a case, the heating unit 120 can set the Curie temperature of barium titanate at 350° C., so that the aerosol-generating article 200 can be heated at a suitable temperature less than 350° C.

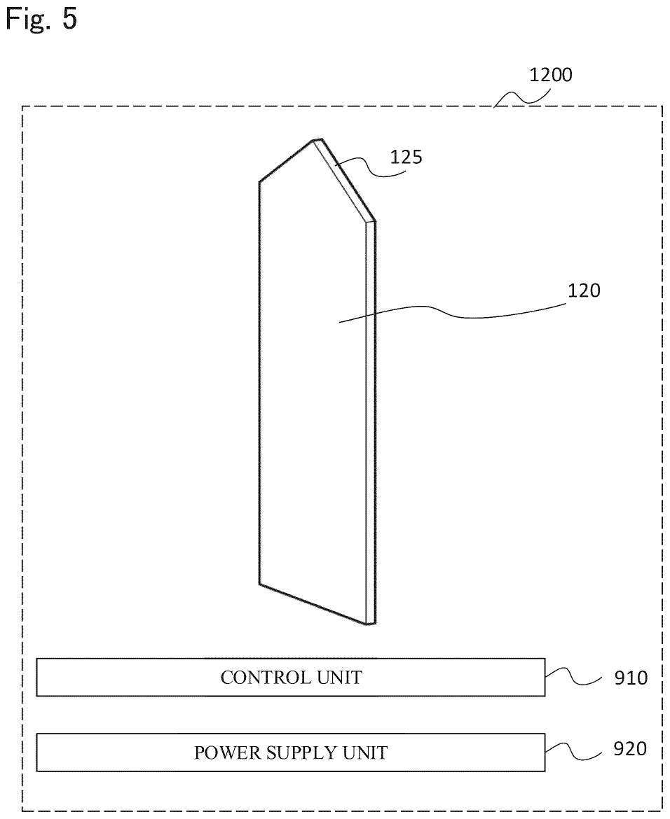

FIG. 5 is a conceptual view of a heating control system 1200 that controls the heating by the heating unit 120. The heating control system 1200 comprises the heating unit 120, a control unit 910, and a power supply unit 920.

In the illustrated example, the heating unit 120 is schematically shown in a perspective view. In the heating unit 120, a protrusion 125 is formed on one side along the longitudinal direction. The heating unit 120 is inserted from the protrusion 125 into the aerosol-generating article 200. Therefore, a side of the heating unit 120, on which the protrusion 125 is formed, is a side close to outside when the aerosol-generating article 200 is housed in the housing 110 and is a downstream side of an air flow path during inhalation. From this point of view, in the following embodiment, the side on which the protrusion 125 is formed in the longitudinal direction of the heating unit 120 is referred to as the downstream side, and a side opposite to the downstream side is referred to as an upstream side.

The control unit 910 comprises a control device electrically connected to the heating unit 120, and the control device controls the heating by the heating unit 120. The control device includes a processing device such as a printed circuit board (PCB). This processing device includes a CPU, a memory, and the like, and controls an operation of the aerosol-generating device 100. The control device detects start of the inhalation. Specifically, the control device detects a user's operation on an input device such as a push button or sliding switch (not shown in the figure). Alternatively, the control device detects user's puffing operation with a sensor (not shown in the figure). After this detection, the control device performs processing to start applying a voltage for heating by use of the power supplied from the power supply unit 920. Also, the control device ends the heating if end conditions are met. The end conditions include a condition that a predetermined time elapses from start of heating, a condition that the number of puffing operation times by the user exceeds a certain value, or the like. Note that the heating unit 120 may include a metal body inserted into the aerosol-generating article 200 and may be configured to heat the aerosol-generating article 200 with the induction heated metal body. In this case, the metal body is placed in advance on the aerosol-generating article 200, and the metal body is housed in the housing 110 together with the aerosol-generating article 200, so that the receptacle 1A constituting the housing 110 can heat the aerosol-generating article 200 with the heating unit 120 including the induction heated metal body. As above, from the viewpoint of enabling flexible design, the receptacle 1A may comprise the heating unit 120, or the metal body housed in the receptacle 1A together with the aerosol-generating article 200 may constitute the heating element of the heating unit 120.

The power supply unit 920 includes a battery electrically connected to the heating unit 120 and supplies power to the heating unit 120. The battery is, for example, a lithium-ion battery. The battery may be chargeable by an external power source.

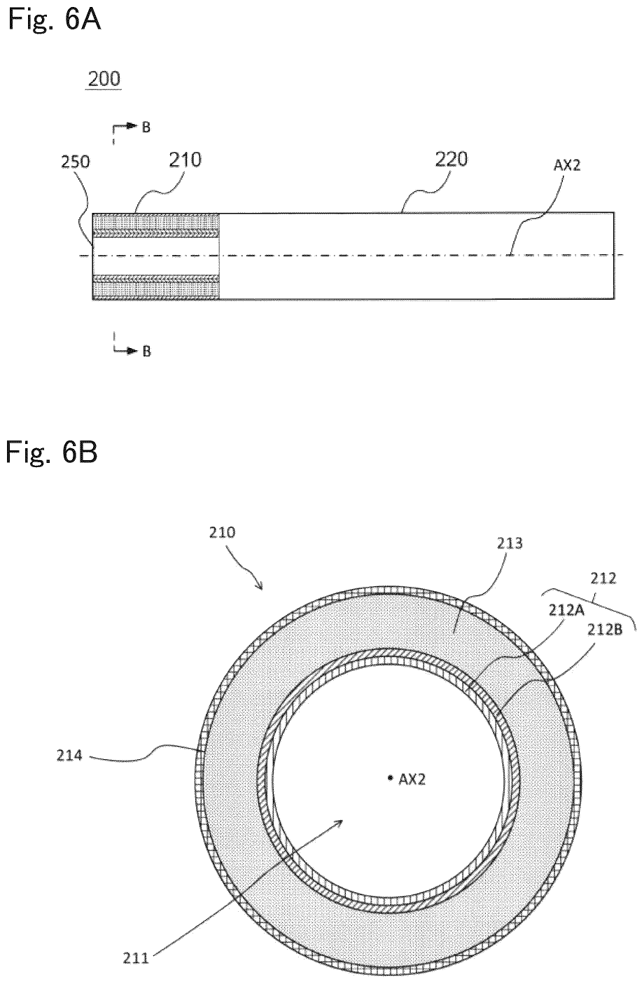

FIG. 6A is a schematic cross-sectional side view showing the aerosol-generating article 200 according to the present embodiment. FIG. 6B is a cross-sectional view (B-B cross-sectional view) showing a cross section of a tobacco part 210 orthogonal to the longitudinal direction of the aerosol-generating article 200 shown in FIG. 6A. The aerosol-generating article 200 may be pillar-shaped, preferably columnar. If the aerosol-generating article 200 can be housed in the housing 110, an end face of the article or a cross section of the article orthogonal to the longitudinal direction may be elliptical or flattened. In the illustrated example, the aerosol-generating article 200 is columnar around an axis of the second central axis AX2. When the aerosol-generating article 200 is inserted into the housing 110 for inhalation, a first inserted end portion is the upstream end portion 250. Accordingly, also, for the aerosol-generating article 200, a side on which the upstream end portion 250 is disposed is appropriately referred to as the upstream side, and a side opposite to the upstream side is appropriately referred to as the downstream side. The upstream end portion 250 can be in a range of about an outer diameter of an end face from the end face in the longitudinal direction from the end face on the upstream side of the aerosol-generating article 200. Here, if the end face is not a circle, the outer diameter is a maximum diameter passing through the center of the end face. For example, if the end face is an ellipse, the outer diameter is a long diameter of the ellipse. As shown in FIGS. 6A and 6B, the aerosol-generating article 200 has the tobacco part (inserted part) 210 and a paper tube 220.

The tobacco part 210 is disposed so that one end of the tobacco part is the upstream end portion 250. The tobacco part 210 has a through hole 211 having a center into which the heating unit 120 is inserted. Furthermore, the tobacco part 210 has a flavor release layer 212 of a two-layer structure disposed to surround the heating unit 120 to be inserted and an elastic deformation layer 213. An outer circumference of the elastic deformation layer 213 is wrapped in a wrapper 214 that is a sheet-shaped packaging material. The paper tube 220 is disposed downstream of the tobacco part 210, to cool volatile compounds released from the flavor release layer 212.

The flavor release layer 212 includes a tobacco sheet 212A, and a non-tobacco sheet 212B disposed on an outer circumference of the tobacco sheet 212A to support glycerin or the like. The flavor release layer 212 comprises the flavor-generating substrate and is heated by the heating unit 120 to release an aerosol or the like having a flavor. The flavor-generating substrate is a material that gives an aromatic taste and is preferably a tobacco material. The flavor-generating substrate may also include fragrance. The fragrance is a substance that provides scent or taste. The fragrance may be a natural fragrance or a synthetic fragrance. As the fragrance, one type of fragrance may be used, or a mixture of multiple types of fragrance may be used. As the fragrance, for example, any fragrance is usable if the fragrance is a usually used fragrance, such as an essential oil, the natural fragrance, or the synthetic fragrance. In addition, the fragrance may be liquid or solid, regardless of properties. Furthermore, the flavor-generating substrate may contain a refreshening agent or a flavoring agent. Note that the flavor release layer 212 can include only one of the tobacco sheet 212A and the non-tobacco sheet 212B.

The elastic deformation layer 213 is made of, for example, a nonwoven fabric sheet, a corrugated sheet, a non-tobacco sheet, or the like and is elastically deformable in the thickness direction (that is, in the radial direction of the tubular elastic deformation layer 213). The elastic deformation layer 213 contributes to deformation of the aerosol-generating article 200 along the shape of the heating unit 120 when the heating unit 120 is inserted. Consequently, when the heating unit 120 is inserted into the through hole 211, the elastic deformation layer 213 is elastically deformed in the thickness direction with respect to the heating unit 120 and is easier to contact or approach the heating unit 120. For this reason, the flavor release layer 212 can more easily contact or approach the heating unit 120, and the aerosol-generating article 200 can be efficiently heated.

The tobacco part 210 includes the flavor release layer 212 and the elastic deformation layer 213 that are arranged to surround the inserted heating unit 120, so that when the heating unit 120 is inserted into the aerosol-generating article 200, the shape of the aerosol-generating article 200 can be easily deformed. In addition, the cross-sectional shape of the aerosol-generating article 200 may be circular or elliptical.

The tobacco sheet 212A may include, for example, tobacco, polyhydric alcohol, and the like. The polyhydric alcohol can be used alone or in combination of two or more types on the tobacco sheet 212A. The polyhydric alcohol may also be added to the elastic deformation layer 213 described above. The tobacco sheet 212A may be formed into a sheet by mixing a binder with powdered tobacco and polyhydric alcohol. Furthermore, the non-tobacco sheet 212B may include the flavor-generating substrate.

As shown in FIGS. 1, 2 and 4, the first shaped portions 50A and 50B are formed in the housing 110. Each of the first shaped portions 50A and 50B has a first shape that is a protruding shape. The first shape protrudes away from the side wall 111 or the bottom wall 112. As shown in FIG. 4, protruding end portions 55A and 55B are formed at protruding tips of the first shaped portions 50A and 50B, respectively. The protruding end portions 55A and 55B abut on the upstream end portion 250 of the aerosol-generating article 200, when the aerosol-generating article 200 in which the second shaped portion 3000 is not formed is housed in the housing 110. This abutment impedes movement of the upstream end portion 250 of the aerosol-generating article 200 in an inserting direction. Based on a shape of the protruding end portions 55A and 55B, the upstream end portion 250 is subjected to a reaction of a force of pushing the protruding end portions 55A and 55B and folded inside the aerosol-generating article 200. A folded portion of the upstream end portion 250 forms the second shaped portion 3000. Here, “folding” means deforming the upstream end portion 250 not only in the radial direction but also in the inserting direction. Hereinafter, when the first shaped portions 50A and 50B are not distinguished from each other, the portions are each referred to as a first shaped portion 50, and when the protruding end portions 55A and 55B are not distinguished from each other, the portions are each referred to as a protruding end portion 55.

The first shaped portion 50 is configured such that the upstream end portion 250 of the aerosol-generating article 200 is foldable inside the aerosol-generating article 200. The first shaped portion 50 functions as a folding portion that folds the upstream end portion 250 inside the aerosol-generating article 200. The upstream end portion 250 is an end portion on a bottom wall 112 side of the aerosol-generating article 200, when the aerosol-generating article 200 is housed in the housing 110. The first shaped portion 50 can fold at least the upstream end portion 250 inside the aerosol-generating article 200, when the upstream end portion 250 of the aerosol-generating article 200 inserted into the housing 110 is not folded.

The present inventor et al have found that on folding the upstream end portion 250 inside the aerosol-generating article 200, the aerosol-generating article 200 is less likely to remain in the housing 110 when the user takes the aerosol-generating article 200 out of the housing 110. This can inhibit reduction of the heating efficiency due to a part of the aerosol-generating article 200, such as a heated flavor-generating substrate, sticking to the heating unit 120. For example, frequency of cleaning of the interior of the housing 110 can be reduced, to facilitate maintenance of the aerosol-generating device 100. The aerosol-generating device 100 according to the present embodiment achieves these effects without the need for increased complexity and size.

The first shaped portion 50 preferably folds the upstream end portion 250 of the aerosol-generating article 200 toward the heating unit 120, particularly toward a central axis of the heating unit 120 extending in the longitudinal direction. For example, when the heating unit 120 is disposed on the first central axis AX1 of the receptacle 1A constituted by the housing 110, the first shaped portion 50 may be configured to fold the upstream end portion 250 in the radial direction. In such a configuration, when the aerosol-generating article 200 is taken out of the housing 110, the contents of the aerosol-generating article 200 disposed between the wrapper 214 and the heating unit 120 are held and pushed out by the folded upstream end portion 250, and the contents can be more securely inhibited from remaining in the housing 110.

The first shaped portion 50 is provided in contact with the side wall 111 and the bottom wall 112 of the housing 110 in the bottom 1B of the receptacle 1A. The protruding end portion 55 is provided on a side opposite to the bottom wall 112, that is, downstream in the first shaped portion 50. For this reason, the protruding end portion 55 is opposite to the upstream end portion 250 of the aerosol-generating article 200, when the aerosol-generating article 200 is inserted from the opening 115 of the housing 110. When the aerosol-generating article 200 does not have the second shaped portion 3000, the protruding end portion 55 abuts on the upstream end portion 250, and the upstream end portion 250 can be folded to form the second shaped portion 3000. Therefore, the user does not need any special operation for forming the second shaped portion 3000. Note that if the second shaped portion 3000 can be formed on the upstream end portion 250, the first shaped portion 50 may be provided in contact with either one of the side wall 111 or the bottom wall 112 of the housing 110. Alternatively, the first shaped portion 50 may be formed as a part of the side wall 111 and the bottom wall 112.

In the present embodiment, the protruding end portion 55 is formed in a linear or strip shape on the surface of the first shaped portion 50. This has following advantages. When the wide protruding end portion 55 abuts on the upstream end portion 250 of the aerosol-generating article 200, the contents of the aerosol-generating article 200 move in a direction (for example, direction along the Y-axis) intersecting a pressing direction of the protruding end portion 55, and the upstream end portion 250 expands. In this case, when the aerosol-generating article 200 is taken out of the housing 110, the contents cannot be held by the upstream end portion 250, the contents fall from the expanded upstream end portion 250, and the contents are likely to remain in the housing 110. If the linear or strip-shaped protruding end portion 55 abuts on the aerosol-generating article 200, as compared with a case where the wide protruding end portion 55 abuts, the upstream end portion 250 does not expand, and the contents are less likely to remain in the housing 110 when the aerosol-generating article 200 is taken out of the housing 110. Note that if the second shaped portion 3000 can be formed on the upstream end portion 250, the shape of the protruding end portion 55 is not particularly limited and can be constituted by any flat or curved surface or the like.

The surface of the first shaped portion 50 that constitutes the protruding end portion 55 is preferably inclined with respect to the first central axis AX1 of the receptacle 1A. The protruding end portion 55 is preferably inclined so that a tangent plane of the protruding end portion 55 intersects the first central axis AX1 on the bottom wall 112 side (upstream side) away from the protruding end portion 55. Here, “inclined” indicates that the protruding end portion 55 is non-perpendicular and nonparallel to the first central axis AX1. In consideration of manufacturing errors and the like, the protruding end portion 55 is preferably inclined by 5 degrees or more from a direction perpendicular to the first central axis AX1. The protruding end portion 55 inclined in this way can bias the upstream end portion 250 toward inside the aerosol-generating article 200 and form the second shaped portion 3000, when the aerosol-generating article 200, on which the second shaped portion 3000 is not formed, is inserted into the housing 110. Therefore, when the aerosol-generating article 200 is taken out of the housing 110, the contents of the aerosol-generating article 200 are even less likely to remain in the housing 110.

An angle formed by the first central axis AX1 of the receptacle 1A and the tangent plane of the protruding end portion 55 is an inclination angle θ. The inclination angle θ is larger than 0 degrees and smaller than 90 degrees. The inclination angle θ is preferably 30 degrees or more. The larger the inclination angle θ is, the more the protruding end portion 55 having an angle close to perpendicular to the inserting direction of the aerosol-generating article 200 abuts. Therefore, when inserting, into the housing 110, the aerosol-generating article 200 that does not have the second shaped portion 3000, the folding of the upstream end portion 250 is facilitated. The inclination angle θ is preferably 60 degrees or less. If the inclination angle θ is excessively large, the aerosol-generating article 200 is hard to fold inward, and when the aerosol-generating article 200 is taken out of the housing 110, the contents cannot be held. The inclination angle θ is more preferably in a range of 30 degrees or more and 60 degrees or less. In addition, if the protruding end portion 55 is a curved surface or is formed in a stepped shape and the inclination angle θ takes a plurality of continuous or discrete values, all or part of the inclination angle θ can be within the above range.

If the first shaped portion 50 can bias the upstream end portion 250 of the aerosol-generating article 200, which does not have the second shaped portion 3000, and can form the second shaped portion 3000, the shape of the first shaped portion 50 is not particularly limited. The first shaped portion 50 preferably has a blade shape. Consequently, a narrow protruding end portion 55 can be formed, and a portion other than the protruding end portion 55 in the first shaped portion 50 can be inhibited from pressing against the aerosol-generating article 200 to expand the upstream end portion 250.

As shown in FIGS. 1 and 4, the first shape of the first shaped portion 50 preferably includes a sharp shape extending along the radial direction and tapering toward the first central axis AX1. When the first shaped portion 50 has such a sharp shape, the contents of the aerosol-generating article 200 can be inhibited from being pushed out in the direction intersecting the direction in which the protruding end portion 55 presses against the contents of the aerosol-generating article 200 (for example, the direction along the Y-axis) to expand the upstream end portion 250. As a result, the protruding end portion 55 is less likely to expand the upstream end portion 250 when the upstream end portion 250 of the aerosol-generating article 200 is biased inward. Therefore, when the aerosol-generating article 200 is taken out of the housing 110, the contents are further less likely to remain in the housing 110.

As shown in FIG. 2, a height along the first central axis AX1 is a first height H10, and a width of the first shape in a certain direction at the first height H10 is a first width W10. In the illustrated example, the first width W10 in the width direction is shown. In the radial direction, circumferential direction, or some other direction, the first width W10 preferably gradually decreases or increases along the first central axis AX1. In the illustrated example, the first width W10 in the width direction gradually increases upstream along the first central axis AX1. Thus, since the first shape does not change rapidly, any sharp portion is not formed, and damages can be reduced when the aerosol-generating article 200 abuts on the first shape.

The first shaped portion 50 can form the second shaped portion 3000 on the upstream end portion 250 of the aerosol-generating article 200, and then the number of first shaped portions 50 arranged in the receptacle 1A is not particularly limited and can be 1 or more. From the viewpoint of more securely holding the contents of the aerosol-generating article 200 by the upstream end portion 250 having a plurality of second shaped portions 3000, it is preferable that a plurality of first shaped portions 50 is provided in the receptacle 1A. In this case, from a similar point of view, it is preferable to fold the upstream end portion 250 from a plurality of directions, and therefore, as in the first shaped portions 50A and 50B, a plurality of first shaped portions 50 is preferably provided at different circumferential positions with respect to the first central axis AX1 in the housing 110.

A distance between two first shaped portions 50A and 50B in a certain direction along the bottom wall 112, that is, along a XY-plane is a shaped portion distance D1. A width of the heating unit 120 in the direction is a heating unit width W1. In the illustrated example, the shaped portion distance D1 and the heating unit width WI are measured along an X-axis direction. Thus, if the plurality of first shaped portions 50A and 50B is arranged at opposite positions via the heating unit 120, in a certain direction along the bottom wall 112, the heating unit width W1 is preferably 60% or more and further preferably 70% or more of the shaped portion distance D1. Since the distance between the first shaped portion 50 and the heating unit 120 is short, regardless of the width of the aerosol-generating article 200, the upstream end portion 250 of the aerosol-generating article 200 housed in the housing 110 can be folded to a position close to the heating unit 120. Therefore, when the aerosol-generating article 200 is taken out of the upstream end portion 250, the contents are even less likely to remain in the housing 110.

In the illustrated example, the first shaped portions 50A and 50B are each disposed along the X-axis direction in which the plate-shaped heater constituting the heating unit 120 extends. Thus, the first shaped portion 50 is preferably disposed along the direction in which the heating unit 120 extends, in the bottom 1B of the receptacle 1A. This can shorten the distance between the first shaped portion 50 and the heating unit 120. Furthermore, the aerosol-generating device 100 can be formed thinner in the thickness direction and can be made compacter. It should be noted that, if the first shaped portion 50 can form the second shaped portion 3000 on the upstream end portion 250, a position or the like of the first shaped portion 50 can be appropriately adjusted.

The first shaped portion 50A is disposed opposite to one end of the heating unit 120 on a minus side in the X-axis direction (width direction). The first shaped portion 50B is disposed opposite to one end of the heating unit 120 on a plus side in the X-axis direction. Thus, the first shaped portion 50 may be disposed at one end of the plate-shaped heating unit 120 in the bottom wall 112, preferably at each of the positions opposite to both ends. This can further shorten the distance between the first shaped portion 50 and the heating unit 120. Furthermore, the aerosol-generating device 100 can be formed even thinner in the thickness direction and can be made even compacter.

As shown in FIG. 3, the plate-shaped heater constituting the heating unit 120 has a first main surface 1201 perpendicular to the thickness direction (Y-axis direction) and a second main surface 1202 formed on a back side of the first main surface 1201. The pressing rib 30 is formed on the side wall 111 opposite to the first main surface 1201 and the second main surface 1202. In contrast, the first shaped portions 50A and 50B are arranged along the width direction of the heating unit 120. When the first shaped portions 50A and 50B press against the upstream end portion 250 along the width direction, the contents of the aerosol-generating article 200 can be pushed out in the thickness direction intersecting a pressed direction. Therefore, the pressing rib 30 biases the aerosol-generating article 200 inward along the thickness direction, so that it is possible to inhibit the upstream end portion 250 from expanding and to inhibit the contents from remaining in the housing 110 when the aerosol-generating article 200 is taken out of the housing 110. The pressing rib 30 may be disposed opposite to only one of the first main surface 1201 or the second main surface 1202.

If the first shaped portion 50 withstands heat of the heating unit 120 and can be processed into that shape, a material of the first shaped portion is not particularly limited. The first shaped portion 50 may be formed of, for example, a resin such as PC, ABS resin, PEEK or polymer alloy, or a metal such as aluminum. A method of forming the first shaped portion 50 is not particularly limited. After forming the side wall 111 and the bottom wall 112 of the housing 110, the first shaped portion 50 can be attached by bonding or the like. Alternatively, the first shaped portion 50 may be formed integrally with the side wall 111 and the bottom wall 112 by resin molding or die casting.

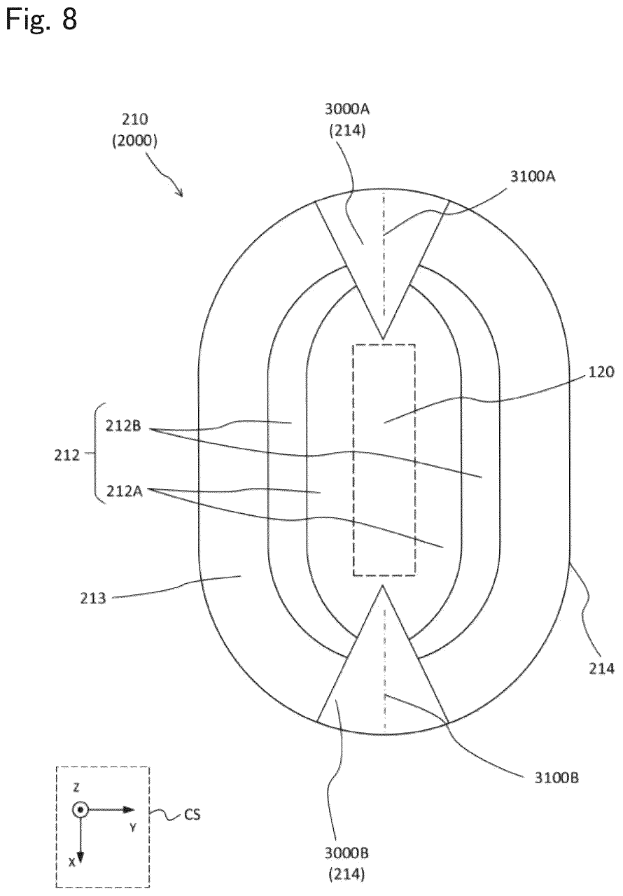

FIG. 7 is a side view schematically showing the aerosol-generating article 200 in which second shaped portions 3000A and 3000B are formed by abutment on the first shaped portions 50A and 50B of the receptacle 1A, respectively. FIG. 8 is a conceptual view (schematic side view on arrows C-C) showing an end face of the aerosol-generating article 200 of FIG. 7 on the bottom wall 112 side (upstream side). Hereinafter, for clarity, the aerosol-generating article 200 housed in the receptacle 1A is appropriately referred to as a housed article 2000. In the housed article 2000, the second shaped portions 3000A and 3000B are formed at opposite ends along the width direction (X-axis direction) of the upstream end portion 250 of the tobacco part 210. In the following embodiment, when the second shaped portions 3000A and 3000B are not distinguished from each other, the portions are each referred to as the second shaped portion 3000. The second shaped portions 3000A and 3000B are portions formed by folding the upstream end portion 250 inside the housed article 2000 in abutment on the first shaped portions 50A and 50B, when inserted into the receptacle 1A. FIG. 7 schematically shows an example of an outline of a folded portion in the upstream end portion 250 with a double-dashed chain line.

FIG. 8 schematically shows an outline of a cross section of the heating unit 120 with a dashed line. The housed article 2000, into which the heating unit 120 is inserted, expands in the width direction (X-axis direction) in which the heating unit 120 extends. In the upstream end portion 250, pressed portions 3100A and 3100B, on which the protruding end portions 55A and 55B abut, respectively, are pressed more strongly, and the pressed portions are biased to inside the housed article 2000. In the present embodiment, since the protruding end portion 55 is linear or strip-shaped, the pressed portions 3100A and 3100B are also linear or strip-shaped. Furthermore, the protruding end portion 55 has a convex portion, and hence the second shaped portion 3000 has a concave portion. By utilizing the convex portion, the housed article 2000 can be easily deformed. Thus, the upstream end portion 250 is configured to have a second shape corresponding to a first shape, when the aerosol-generating article 200 is housed in the receptacle 1A. The second shape is configured to inhibit the contents from remaining in the receptacle 1A, when the aerosol-generating article 200 is taken out of the receptacle 1A.

The surface of the second shaped portion 3000 is inclined with respect to the longitudinal direction of the aerosol-generating article 200 or in the inserting direction (Z-axis direction) of the aerosol-generating article 200. Specifically, at least part of the surface of the second shaped portion 3000 is inclined so that a tangent plane TP of the at least part intersects the second central axis AX2 on an end face side of the upstream end portion 250 away from the at least part. For this reason, the second shaped portion 3000 functions as a holding portion that holds contents such as the flavor release layer 212 placed in the inserting direction with respect to the second shaped portion 3000. The housed article 2000 is removed so that the contents held in this manner do not remain in the receptacle 1A. Thus, the aerosol-generating article 200 according to the present embodiment is configured such that when the article is housed in the receptacle 1A, the surface of the second shaped portion 3000 is inclined with respect to the inserting direction and serves as the holding portion. In the illustrated example, the second shaped portion 3000 partially covers the tobacco sheet 212A, the non-tobacco sheet 212B and the elastic deformation layer 213. However, if the effect of inhibiting the contents from remaining in the receptacle 1A to a desired extent can be obtained when the housed article 2000 is taken out of the housing 110, a range of the end face of the aerosol-generating article 200 covered with the second shaped portion 3000 is not particularly limited.

The surface of the second shaped portion 3000 is preferably formed by the wrapper 214 that is the packaging material packaging the upstream end portion 250. Consequently, the aerosol-generating system 10 can be efficiently manufactured at reduced cost so that when the aerosol-generating article 200 is taken out of the receptacle 1A, the contents are less likely to remain in the receptacle 1A. It is preferable to configure the aerosol-generating article 200 and the first shaped portion 50 so that when the aerosol-generating article 200 is housed in the receptacle 1A, a fold of the wrapper 214 of the packaging material toward inside the upstream end portion 250 is formed. Accordingly, the contents of the housed article 2000 can be more securely inhibited from remaining in the receptacle 1A, when the housed article 2000 is taken out of the receptacle 1A. Furthermore, the aerosol-generating article 200 having such an effect can be easily formed by folding the packaging material.

In the aerosol-generating article 200, a basis weight of the packaging material in a portion constituting the second shaped portion 3000 when the aerosol-generating article 200 is housed in the receptacle 1A is preferably 20 gsm or more, and further preferably 100 gsm or more. The larger the basis weight is, the higher the strength of the packaging material becomes, and the contents of the housed article 2000 can be firmly held to strongly inhibit positional shift. The basis weight of the packaging material in the above portion constituting the second shaped portion 3000 is preferably 200 gsm or less. If the basis weight is excessively large, adverse effects may occur such as making it difficult to form the second shaped portion 3000 or making it impossible to form the aerosol-generating article 200 compactly. When the wrapper 214 has a plurality of layers as described later, a sum of basis weights of a plurality of layers superimposed on one another can be defined as the basis weight of the packaging material.

The second shaped portion 3000A is formed at one end of the housed article 2000 on a minus side in the X-axis direction (width direction). The second shaped portion 3000B is formed at one end of the housed article 2000 on a plus side in the X-axis direction. Thus, it is preferable to configure the aerosol-generating article 200 and the first shaped portion 50 so that the second shaped portions 3000 are arranged, respectively, on opposite sides of the upstream end portion 250 along a direction perpendicular to the longitudinal direction of the housed article 2000. Consequently, when the housed article 2000 is taken out of the receptacle 1A, the contents of the housed article 2000 are held by the second shaped portions 3000 on the opposite sides of the upstream end portion 250 of the housed article 2000, and the contents can be more securely inhibited from remaining in the receptacle 1A.

As shown in FIG. 7, a height along the second central axis AX2 is a second height H20, and a width of the second shape in a certain direction at the second height H20 is a second width W20. In the illustrated example, the second width W20 in the width direction is shown. In the radial direction, the circumferential direction, or some other direction, the second width W20 preferably increases as being toward an upstream end face along the second central axis AX2. In the illustrated example, the second width W20 in the width direction gradually increases upstream along the second central axis AX2. Consequently, for a wider range of contents in the housed article 2000, when the housed article 2000 is taken out of the receptacle, the contents can be inhibited from remaining in the receptacle 1A.

As shown in FIG. 4, from the viewpoint of smoothly performing the folding, the receptacle 1A constituted by the housing 110 preferably comprises a non-folding portion 155 that is adjacent to the first shaped portion 50 in the circumferential direction with respect to the central axis AX1 and that does not fold the upstream end portion 250. In other words, the first shaped portion 50 preferably does not have the protruding end portion 55 that is continuous over an entire circumference in the circumferential direction.

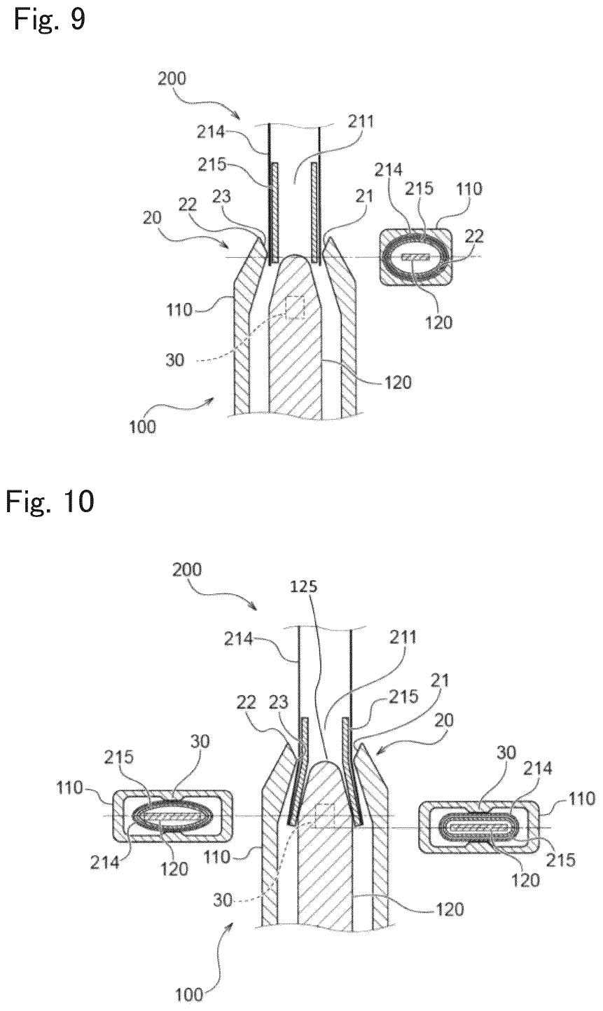

Subsequently, relationships between the aerosol-generating article 200, the housing 110 and the heating unit 120 will be described when the aerosol-generating article 200 is housed in the aerosol-generating device 100, that is, when the aerosol-generating article 200 is inserted from one end side (downstream side) toward the other end side (upstream side) of the housing 110. FIGS. 9 to 11 are cross-sectional views showing a housed state of the aerosol-generating article 200 in the aerosol-generating device 100. FIGS. 9 to 11 show the flavor release layer 212 and the elastic deformation layer 213 of the aerosol-generating article 200 as one annular sheet 215.

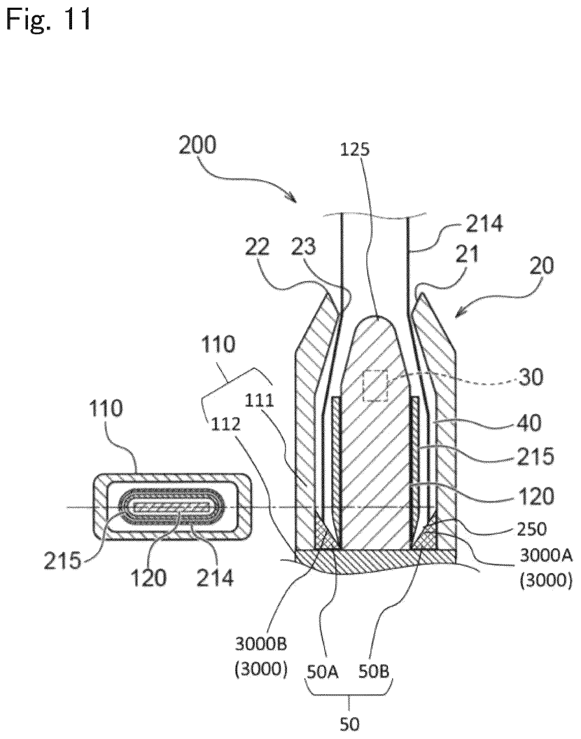

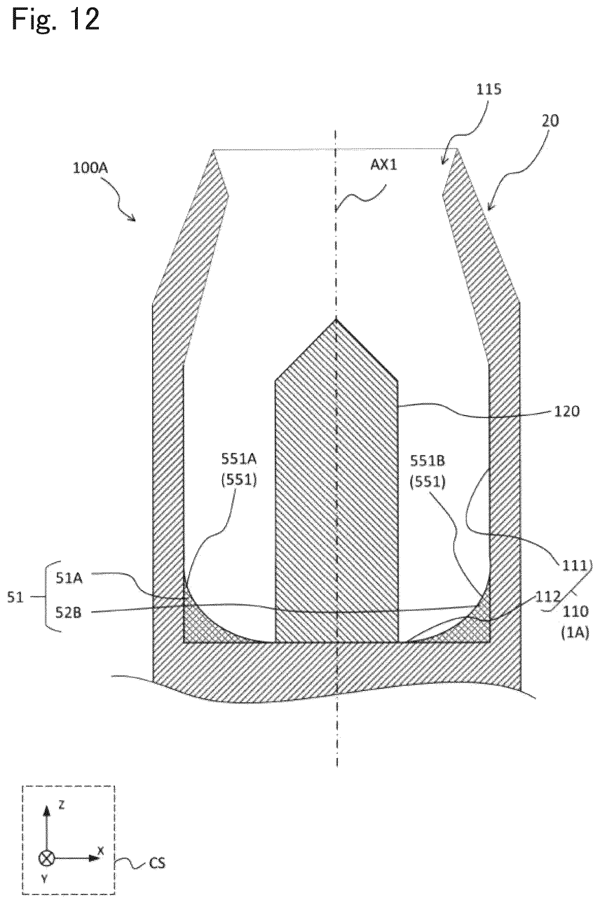

FIG. 9 shows a state of the aerosol-generating article 200 passing through the shaping guide 20, in a cross section of the heating unit 120 in the width direction, and a cross section of the housing 110 that is orthogonal to the longitudinal direction in an inlet portion 22 of the shaping guide 20. FIG. 10 shows a state of the aerosol-generating article 200 passing through the pressing rib 30, in a cross section of the heating unit 120 in the width direction, and a cross section of the housing 110 that is orthogonal to the longitudinal direction of the housing 110 in a middle portion and the other end portion of the pressing rib 30. FIG. 11 shows a state of the aerosol-generating article 200 housed at a predetermined housing position of the housing 110, in a cross section of the heating unit 120 in the width direction, and a cross section of the housing 110 that is orthogonal to the longitudinal direction of the housing 110 in the vicinity of an end portion of the heating unit 120 on the other end side.

As shown in FIG. 9, the shaping guide 20 has a tapered portion 21, the inlet portion 22, and a deforming portion 23. The tapered portion 21 is configured to expand toward one end side of the housing 110, and guides the insertion of the aerosol-generating article 200 into the aerosol-generating device 100. The inlet portion 22 is provided in the end portion of the housing 110, has an elliptical cross section, and is configured to have a long diameter equal to or more than a long diameter of the aerosol-generating article 200 after being housed in the housing 110 and a short diameter having almost the same length as a diameter of the aerosol-generating article 200 before being housed in the housing 110. Furthermore, the deforming portion 23 is provided on an inner peripheral surface of the housing 110, has an elliptical cross section, and is configured to have a minimum inner circumference length that is almost equivalent to an outer circumference length of the aerosol-generating article 200. Consequently, when the aerosol-generating article 200 passes through the shaping guide 20, the entire circumference of the aerosol-generating article 200 contacts the deforming portion 23, and the cross-sectional shape of the aerosol-generating article 200 can be therefore deformed along the shape of the inlet portion 22.

As shown in FIG. 10, the heating unit 120 has the protrusion 125 having one end pointed and is configured to have a width expanded toward the other end. Consequently, as the aerosol-generating article 200 passes through the shaping guide 20 and is inserted, the outer shape of the aerosol-generating article 200 is deformed along the shape of the heating unit 120. Specifically, the aerosol-generating article 200 is pushed out in the width direction of the heating unit 120. Consequently, the aerosol-generating article 200 can come in contact closely with the heating unit 120, and heat transfer efficiency from the heating unit 120 to the aerosol-generating article 200 can improve. Furthermore, the heating unit 120 can push out the aerosol-generating article 200, to prevent the aerosol-generating article 200 from falling out.

In the illustrated example, the heating unit 120 has a flat plate shape and deforms the outer shape of the aerosol-generating article 200 inserted into the housing 110 into an elliptical cross-sectional shape. At this time, a long diameter of the aerosol-generating article 200 after being housed in the housing 110 is longer than a diameter of the aerosol-generating article 200 before being housed in the housing 110, and a short diameter of the aerosol-generating article 200 after being housed in the housing 110 is shorter than the diameter of the aerosol-generating article 200 before being housed in the housing 110. Since the heating unit 120 deforms the outer shape of the aerosol-generating article 200 inserted into the housing 110 into the elliptical cross-sectional shape, the distance of the housing 110 in a short direction occupied by the aerosol-generating article 200 shortens. Therefore, the housing 110 can be thinner. Furthermore, since the heating unit 120 deforms the outer shape of the aerosol-generating article 200 inserted in the housing 110 into the elliptical cross-sectional shape, a contact area between the heating unit 120 and the aerosol-generating article 200 can increase. Therefore, the heat transfer efficiency from the heating unit 120 to the aerosol-generating article 200 can improve. Furthermore, the aerosol-generating article 200, biased by the pressing rib 30, can be further in close contact with the heating unit 120, and the heat transfer efficiency can further improve. The aerosol-generating article 200, biased by the pressing rib 30, can be prevented from falling out.

As shown in FIG. 11, when the upstream end portion 250 of the aerosol-generating article 200 reaches the bottom wall 112, the first shaped portions 50A and 50B fold the upstream end portion 250 inwardly, to form the second shaped portions 3000A and 3000B. Furthermore, in a housed state of the aerosol-generating article 200 at the predetermined housing position of the housing 110, an air layer 40 is formed between the aerosol-generating article 200 and the housing 110 over the entire circumference of the aerosol-generating article 200. The air layer 40, having a low thermal conductivity, can insulate a space between the aerosol-generating article 200 and the housing 110 and can reduce energy required for heating the aerosol-generating article 200. Furthermore, the inlet portion 22 is in abutment on the aerosol-generating article 200 over the entire outer circumference of the aerosol-generating article 200, to seal the air layer 40. This inhibits convection of air in the air layer 40.

In the aerosol-generating system 10 according to the present embodiment, the first shaped portion 50 having the protruding first shape is formed on the bottom 1B of the receptacle 1A, and the aerosol-generating article 200 comprises the upstream end portion 250 inserted into the receptacle 1A. The upstream end portion 250 is configured to include the second shaped portion 3000 having the second shape corresponding to the first shape, when the aerosol-generating article 200 is housed in the receptacle 1A. At least part of the surface of the second shaped portion 3000 is inclined with respect to the longitudinal direction of the aerosol-generating article 200. This inhibits increased complexity or size of the aerosol-generating device 100, while the second shape corresponding to the protruding first shape can inhibit the contents of the aerosol-generating article 200 from remaining in the receptacle 1A, when the aerosol-generating article 200 is taken out of the receptacle 1A. This can reduce the need for maintenance such as cleaning of the aerosol-generating device 100. Furthermore, reduction of the heating efficiency can be inhibited by inhibiting the aerosol-generating article 200 from adhering to the heating unit 120.

In the aerosol-generating system 10 according to the present embodiment, the upstream end portion 250 of the aerosol-generating article 200 does not comprise the second shaped portion 3000, and the upstream end portion 250 and the first shaped portion 50 are configured such that the upstream end portion 250 is pressed by the first shaped portion 50 to form the second shaped portion 3000, when the aerosol-generating article 200 is inserted into the receptacle 1A. Consequently, it is not necessary to process the second shaped portion 3000 in advance on the aerosol-generating article 200, and when the aerosol-generating article 200 is taken out of the receptacle 1A, the contents of the aerosol-generating article 200 can be inhibited from remaining in the receptacle 1A.

Such variants below are also within the scope of the present invention and can be combined with the above-described embodiment or other variants. In such modifications below, parts that exhibit the same structure and function as in the above-described embodiment are denoted with the same reference signs, and the description is omitted as appropriate.

### Modification 1-1

In the above-described embodiment, the protruding end portion 55 of the first shaped portion 50 may have a steeper inclination relative to the bottom wall 112 as being away from the first central axis AX1.

FIG. 12 is a schematic cross-sectional side view showing a configuration of an aerosol-generating device 100A in an aerosol-generating system according to the present modification. The aerosol-generating device 100A has almost the same configuration as the aerosol-generating device 100 of the above-described embodiment and is different from the aerosol-generating device 100 in comprising first shaped portions 51A and 51B having protruding end portions 551A and 551B, respectively, in place of the first shaped portions 50A and 50B. When the first shaped portions 51A and 51B are not distinguished from each other, the portions are each referred to as a first shaped portion 51. When the protruding end portions 551A and 551B are not distinguished from each other, the portions are each referred to as a protruding end portion 551. Although the first shaped portion 51 has a bottom surface (not shown in the figure) in the same manner as the first shaped portion 50 of the above-described embodiment, the protruding end portion 551 is different from the protruding end portion 55 of the above-described embodiment in having an arched shape that is convex on an upstream side. This can provide the aerosol-generating device 100A that is hard to disturb insertion of an aerosol-generating article 200 into a housing 110, while forming a second shaped portion 3000 by the first shaped portion 51.

### Modification 1-2

In the above-described embodiment, the protruding end portion 55 of the first shaped portion 50 may have a gentler inclination relative to the bottom wall 112 as being away from the first central axis AX1.

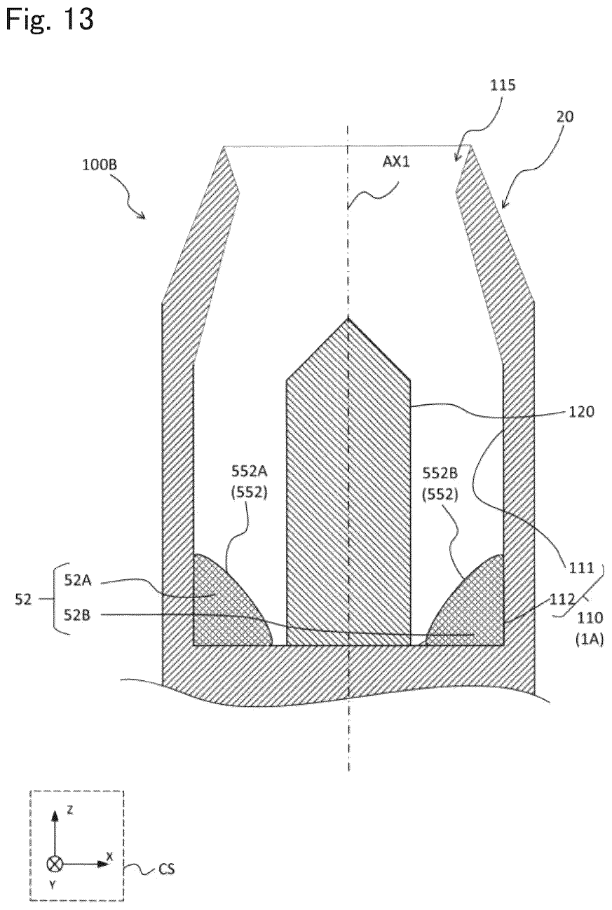

FIG. 13 is a schematic cross-sectional side view showing a configuration of an aerosol-generating device 100B of an aerosol-generating system according to the present modification. The aerosol-generating device 100B has almost the same configuration as the aerosol-generating device 100 of the above-described embodiment and is different from the aerosol-generating device 100 in comprising first shaped portions 52A and 52B having protruding end portions 552A and 552B, respectively, in place of the first shaped portions 50A and 50B. When the first shaped portions 52A and 52B are not distinguished from each other, they are each referred to as a first shaped portion 52. When the protruding end portions 552A and 552B are not distinguished from each other, they are each referred to as a protruding end portion 552. Although the first shaped portion 52 has almost the same bottom surface (not shown in the figure) as in the first shaped portion 50 of the above-described embodiment, the protruding end portion 552 is different from the protruding end portion 55 of the above-described embodiment in having an arched shape that is convex on a downstream side. This can provide the aerosol-generating device 100B in which the protruding end portion 552 easily abuts on the upstream end portion 250 and the second shaped portion 3000 can be more securely formed.

### Modification 1-3

In the above-described embodiment, the heating unit 120 may be a pin type heater.

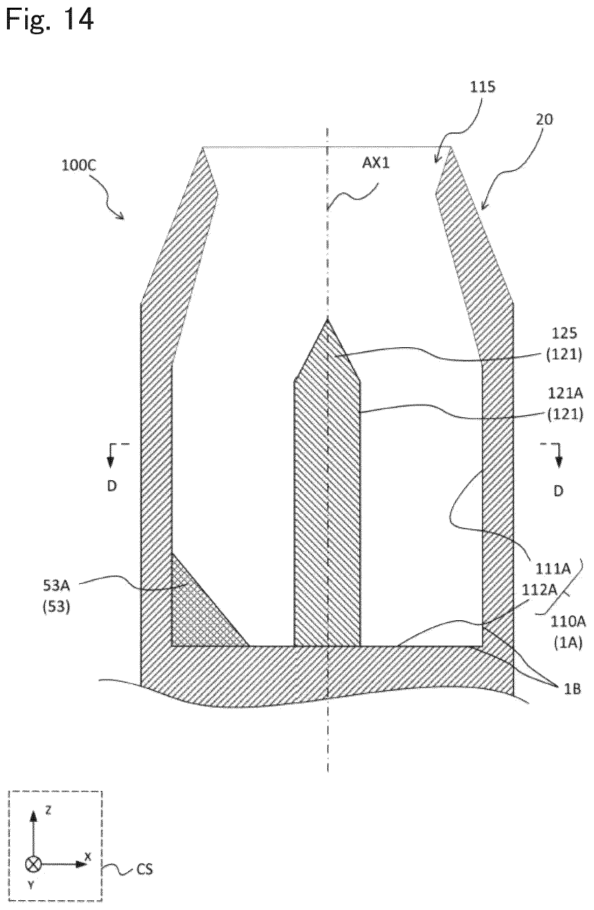

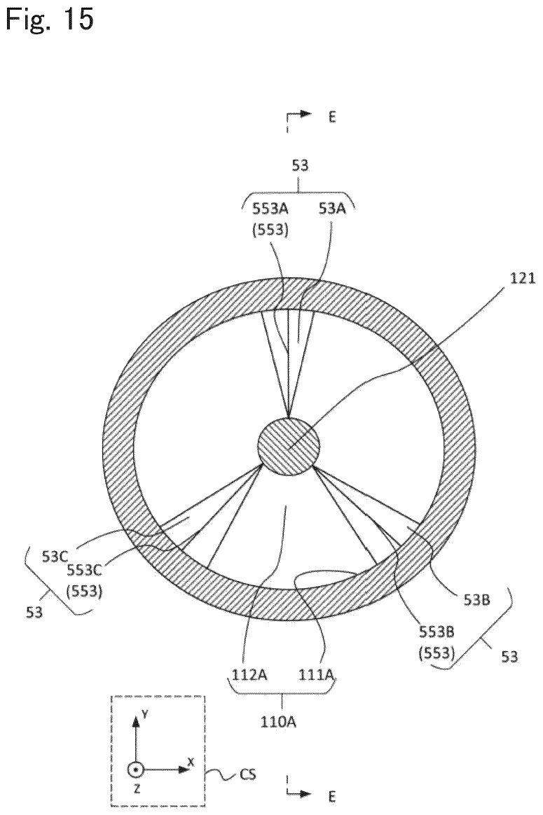

FIG. 14 is a schematic cross-sectional side view of an aerosol-generating device 100C of an aerosol-generating system according to the present modification, and FIG. 15 is a cross-sectional view on arrows D-D of FIG. 14. A cross-sectional side of FIG. 14 corresponds to a cross section on arrows E-E of FIG. 15. The aerosol-generating device 100C has almost the same configuration as the aerosol-generating device 100 in the above-described embodiment and is different from the aerosol-generating device 100 in having a heating unit 121 in place of the heating unit 120 and a housing 110A in place of the housing 110.

The heating unit 121 extends along a first central axis AX1 and comprises a heating unit body 121A and a protrusion 125. The protrusion 125 having a sharp shape is formed downstream of the pillar-shaped heating unit body 121A. The heating unit 121 includes a heating element disposed on the heating unit body 121A disposed inside a receptacle 1A constituted by the housing 110A. Consequently, the heating unit 121 can heat, from inside, the aerosol-generating article 200 into which the heating unit 121 is inserted. The heating element is not particularly limited if the heating element can heat the aerosol-generating article 200, and can be, for example, an electric heating wire or a metal body that generates heat by induction heating. A shape of the heating unit body 121A is not particularly limited and may be columnar or a polygonal pillar. In this shape, it is preferable that the heating unit body 121A is columnar for facilitating insertion into the aerosol-generating article 200. Furthermore, the heating unit body 121A may be placed in an interior of the aerosol-generating article 200 in advance. In this case, the receptacle 1A constituted by the housing 110A can heat the aerosol-generating article 200 by induction heating of the heating unit body 121A disposed in the receptacle 1A together with the aerosol-generating article 200.

The housing 110A comprises a side wall 111A, a bottom wall 112A, and first shaped portions 53A, 53B and 53C. The bottom wall 112A, and the side wall 111A at a position opposite to the upstream end portion 250 of the aerosol-generating article 200 housed in the receptacle 1A form a bottom 1B. The first shaped portions 53A, 53B and 53C comprise protruding end portions 553A, 553B and 553C, respectively. Hereinafter, when the first shaped portions 53A, 53B and 53C are not distinguished from each other, they are each referred to as a first shaped portion 53. Furthermore, when the protruding end portions 553A, 553B and 553C are not distinguished from each other, they are each referred to as a protruding end portion 553. A shape of the housing 110A is not particularly limited if the housing can house the aerosol-generating article 200 inserted into the heating unit 121. However, from the viewpoint of smoothly folding the upstream end portion 250 by a plurality of first shaped portions 53, it is preferable that the side wall 111A and the bottom wall 112A are rotationally symmetrical about an axis of the first central axis AX1, and it is more preferable that the side wall 111A is cylindrical and the bottom wall 112A is circular as in the illustrated example.

A shape of the first shaped portion 53 is the same as that of the first shaped portion 50 of the above-described embodiment and is not particularly limited if the second shaped portion 3000 can be formed in the upstream end portion 250. In this modification, three first shaped portions 53A, 53B and 53C are formed in contact with the side wall 111A and the bottom wall 112A and symmetrical three times around the first central axis AX1, that is, every 120 degrees. The number of first shaped portions 53 may be 1, 2, 4 or more. The protruding end portion 553 has the same shape as the protruding end portion 55 of the above-described embodiment and is not limited thereto.

Even if the heating unit 121 is the pin-type heater as in the present modification, the first shaped portion 53 can be placed in the housing 110A, and the second shaped portion 3000 can be formed on the upstream end portion 250 of the aerosol-generating article 200. This can inhibit the contents of the aerosol-generating article 200 from remaining in the housing 110A, when the aerosol-generating article 200 is taken out of the housing 110A.

### Modification 1-4

In the above-described embodiment, the heating unit 120 has an internal heating type configuration that heats the aerosol-generating article 200 from inside the aerosol-generating article 200. However, the heating unit 120 is disposed in at least one of the side walls 111 and the bottom wall 112 of the housing 110, and the aerosol-generating article 200 may be heated from outside the aerosol-generating article 200 housed in the housing 110. Even in such a case, the upstream end portion 250 of the aerosol-generating article 200 is folded by the first shaped portion 50, so that when the aerosol-generating article 200 is taken out of the housing 110, a part of the aerosol-generating article 200 can be inhibited from remaining in the housing 110. It is particularly possible to inhibit a portion in the vicinity of the end face of the upstream end portion 250 from adhering to the bottom wall 112 or the like.

### Second Embodiment

An aerosol-generating system 10A according to a second embodiment has an almost identical configuration to that of the aerosol-generating system 10 according to the first embodiment. However, the system is different from the aerosol-generating system 10 according to the first embodiment in that a second shaped portion is formed in advance in an aerosol-generating article. The same part as in the first embodiment is denoted with the same reference signs as in the first embodiment, and the description is omitted as appropriate.

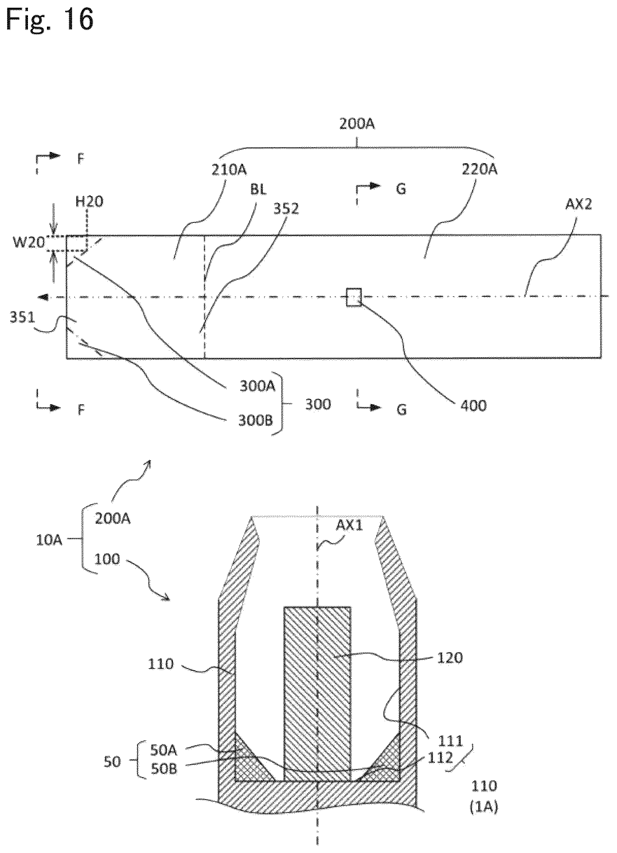

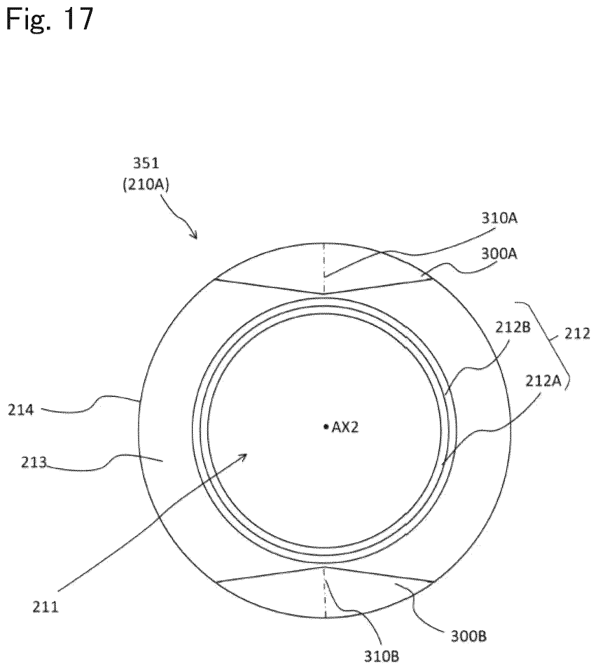

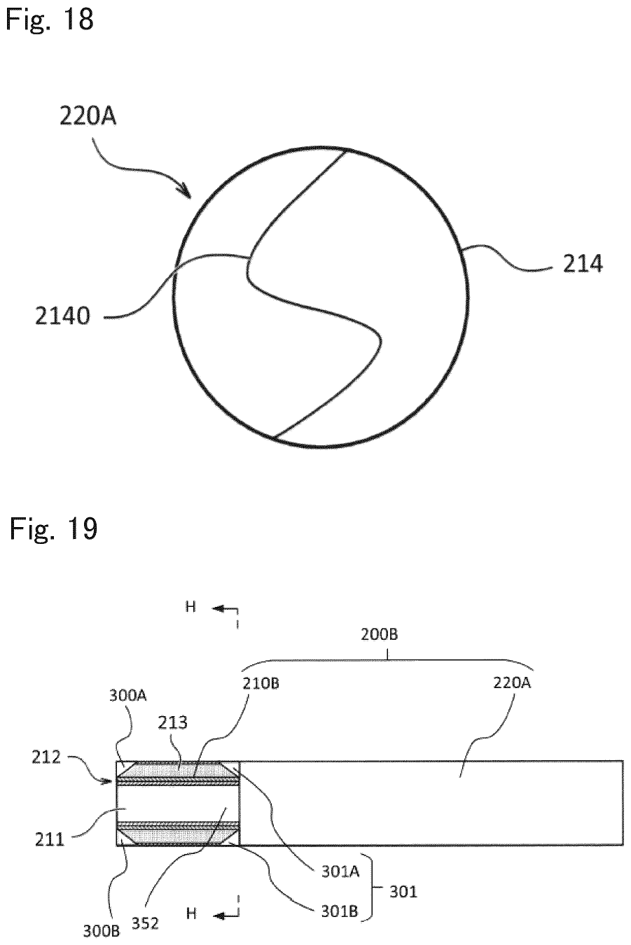

FIG. 16 is a schematic view showing the aerosol-generating system 10A. FIG. 17 is a schematic side view of an aerosol-generating article 200A on arrows F-F of FIG. 16. FIG. 18 is a cross-sectional view of the aerosol-generating article 200A on arrows G-G of FIG. 16. The aerosol-generating system 10A comprises an aerosol-generating device 100 and the aerosol-generating article 200A.

The aerosol-generating article 200A comprises a tobacco part 210A and a paper tube 220A. The tobacco part 210A comprises an upstream end portion 351, a downstream end portion 352, and second shaped portions 300A and 300B. Hereinafter, when the second shaped portions 300A and 300B are not distinguished from each other, they are each referred to as the second shaped portion 300. The tobacco part 210A has about the same configuration as the tobacco part 210 of the above-described embodiment and is different from the tobacco part 210 in that the aerosol-generating article 200A has the second shaped portion 300 before the aerosol-generating article 200A is housed in a receptacle 1A.

As shown in FIGS. 16 and 17, the second shaped portion 300 is formed in the upstream end portion 351 of the tobacco part 210A. In the illustrated example, a wrapper 214 disposed over the tobacco part 210A and the paper tube 220A is folded on an outer side surface of the aerosol-generating article 200A to form the second shaped portion 300.

The second shaped portion 300 inhibits positional shift of contents disposed in the aerosol-generating article 200A. The second shaped portion 300 can inhibit movement of an elastic deformation layer 213 or a flavor release layer 212 in in the tobacco part 210A in a longitudinal direction. Consequently, the contents of the tobacco part 210A are inhibited from failing to be arranged at an appropriate position with respect to a heating unit 120 and from falling out of the aerosol-generating article 200A, and the aerosol-generating system 200A can be therefore inhibited from failing to operate normally due to such causes as above.

The second shaped portion 300 is disposed in the upstream end portion 351. The upstream end portion 351 is an end portion that is first inserted when the aerosol-generating article 200A is inserted into the receptacle 1A. Therefore, since the second shaped portion 300 holds the contents of the aerosol-generating article 200A at an upstream position, the contents can be inhibited from moving upstream. Furthermore, when the aerosol-generating article 200A is taken out of the receptacle 1A, the second shaped portion 300 moves together with the contents while holding the contents, and hence the contents can be inhibited from remaining in the receptacle 1A.

The second shaped portion 300 is formed on an outer peripheral surface of the upstream end portion 351. Consequently, the second shaped portion 300 can be easily formed. For example, the second shaped portion 300 can be formed by pressing a member against a packaging material such as the wrapper 214 disposed on the outer peripheral surface, or by folding the packaging material by a machine or human hand. From the same point of view, it is preferable that the packaging material is disposed on a side surface of the pillar-shaped tobacco part 210A and that in the second shaped portion 300, the packaging material is folded from the side surface toward inside the tobacco part 210A.

In the example of FIG. 17, the second shaped portion 300 has a shape formed by folding the wrapper 214 in a radial direction toward a through hole 211. In the second shaped portions 300A and 300B, folds 310A and 310B are formed, respectively. The second shaped portions 300A and 300B are formed by a blade-shaped member pressing in abutment on and against the wrapper 214. The folds 310A and 310B are formed by abutment of a linear or strip-shaped tip. When the second shaped portion 300 is formed by abutment of a member having the linear or strip-shaped tip, unintended deformation of the tobacco part 210A can be preferably inhibited as compared with a case where a wide member is used. Note that the shape of the second shaped portion 300 is not particularly limited, if the second shaped portion has a shape corresponding to that of a first shaped portion 50 and can inhibit the positional shift of the contents of the aerosol-generating article 200A. For example, the second shaped portion 300 does not need to be formed by folding the packaging material or the like. In addition, the shape of the aerosol-generating article 200A is not particularly limited if the second shaped portion 300 can be formed on the tobacco part 210A. For example, an end face of the aerosol-generating article 200A or a cross section of the aerosol-generating article that is orthogonal to the longitudinal direction may be elliptical or flattened as shown in FIG. 8.

The shape of the second shaped portion 300 can be the same as that of the second shaped portion 3000 of the above-described embodiment. For example, the second shaped portion 300 may comprise the same configuration as that of the second shaped portion 3000 described above, as follows. Consequently, the present embodiment can achieve the same effects as in the above-described embodiment.

As in the above-described embodiment, it is preferable that the surface of the second shaped portion 300 be formed by the wrapper 214 that is the packaging material packaging the aerosol-generating article 200A. This packaging material preferably has a basis weight of 20 gsm or more and 200 gsm or less in a portion constituting the second shaped portion 300. The second shaped portion 300 preferably comprises fold of the packaging material toward inside the upstream end portion 351. The surface of the second shaped portion 300 is preferably inclined with respect to a direction to insert the aerosol-generating article 200A into the receptacle 1A. A width of a second shape (second width W20) in a certain direction perpendicular to the longitudinal direction of the aerosol-generating article 200A preferably increases as being toward an end face of the upstream end portion 351 of the aerosol-generating article 200A. The second shaped portions 300 are preferably arranged on opposite sides of the upstream end portion 351 along the direction perpendicular to the longitudinal direction of the aerosol-generating article 200A.

In the illustrated example, the aerosol-generating article 200A comprises two second shaped portions 300A and 300B. The number of second shaped portions 300 in the aerosol-generating article 200A may be 1 or 3 or more. It is preferable that the same number of second shaped portions 300 be formed as the number of first shaped portions 50 of the aerosol-generating device 100.

The second shaped portion 300 is preferably disposed at a position corresponding to the position of the first shaped portion 50 so that the second shaped portion 300 can be disposed at a position opposite to the first shaped portion 50 when the aerosol-generating article 200A is housed in the receptacle 1A. This can inhibit unnecessary deformation of the upstream end portion 351 due to abutment on the first shaped portion 50. Therefore, it is possible to inhibit an adverse effect such as reduced heating efficiency caused by insufficient alignment between the aerosol-generating article 200A and the heating unit 120.

As shown in FIG. 16, the aerosol-generating article 200A preferably comprises a marker 400. The marker 400 is a marker for inserting the aerosol-generating article 200A into the receptacle 1A so that the first shaped portion 50 is opposite to the second shaped portion 300. In the illustrated example, the marker 400 is a mark drawn on the outer side surface of the aerosol-generating article 200A. A form of the marker 400 is not particularly limited if alignment between the first shaped portion 50 and the second shaped portion 300 is possible. The marker 400 may be, for example, a convex or concave portion formed on the aerosol-generating article 200A, a portion having a distinct color, saturation, or brightness from other portions, or the like. The marker 400 can inhibit an adverse effect such as reduced heating efficiency due to arrangement of the first shaped portion 50 and the second shaped portion 300 at unintended relative positions. It should be noted that, such a marker can be formed on at least one of the aerosol-generating article 200A and the aerosol-generating device 100.

FIG. 18 is a cross-sectional view on arrows G-G of FIG. 16, schematically showing a cross section of the paper tube 220A. The paper tube 220A has the tubular wrapper 214 and a stopper 2140 located in an interior of the wrapper 214. In the present embodiment, a basis weight of the wrapper 214 in the paper tube 220A is preferably 50 g/m² or more and 150 g/m² or less, more preferably 50 g/m² or more and 100 g/m² or less. From the viewpoint that the wrapper 214 maintains an appropriate shape against deformation of the elastic deformation layer 213, the wrapper 214 preferably extends from the paper tube 220A to the tobacco part 210A and is not limited thereto.

The stopper 2140 can prevent the elastic deformation layer 213 from moving from the tobacco part 210A toward the paper tube 220A. Specifically, in the present embodiment, at least part of the stopper 2140 of the paper tube 220A is located on the same radius as a radius of the elastic deformation layer 213 when viewed from the longitudinal direction. In other words, at least part of the stopper 2140 is located to contact the elastic deformation layer 213 in the longitudinal direction. Consequently, when the heating unit 120 is inserted into the through hole 211 and even if force is applied to the elastic deformation layer 213 in a direction toward the paper tube 220A by the heating unit 120, the stopper 2140 can contact the elastic deformation layer 213 and prevent the elastic deformation layer 213 from moving. This can inhibit the aerosol-generating article 200A from being destroyed during the insertion of the heating unit 120. In the present embodiment, the stopper 2140 may be paper having opposite ends connected to separate locations on an inner surface of the tubular wrapper 214 and having a length between the ends that is longer than a diameter of the wrapper 214. This is not restrictive, and the stopper 2140 may adopt any form that can prevent the elastic deformation layer 213 from moving from the tobacco part 210A toward the paper tube 220A. For example, the stopper 2140 may be a sheet having a cross section serving as a chord connecting any two points of the wrapper 214. It should be noted that, the paper tube 220A may further comprise a filter or the like for passing an aerosol having a flavor.

The upstream end portion 351 of the aerosol-generating article 200A of the aerosol-generating system 10A according to the present embodiment comprises the second shaped portion 300, before being housed in the receptacle 1A. Thus, since the second shaped portion 300 is formed in advance, the contents of the aerosol-generating article 20A can be even more securely inhibited from remaining in the receptacle 1A, when the aerosol-generating article 200A is taken out of the receptacle 1A. In contrast, since the first shaped portion 50 is formed in the aerosol-generating device 100, the second shaped portion 300 can be formed again by the first shaped portion 50 even in case of deformation or the like of the second shaped portion 300.

Such variants below are also within the scope of the present invention and can be combined with the above-described embodiment or other variants. In such modifications below, parts that exhibit the same structure and function as in the above-described embodiment are denoted with the same reference signs, and the description is omitted as appropriate.

### Modification 2-1

In the above-described embodiment, a third shaped portion that inhibits positional shift of the contents of the aerosol-generating article 200A may be formed in the downstream end portion 352 of the tobacco part 210A of the aerosol-generating article 200A.

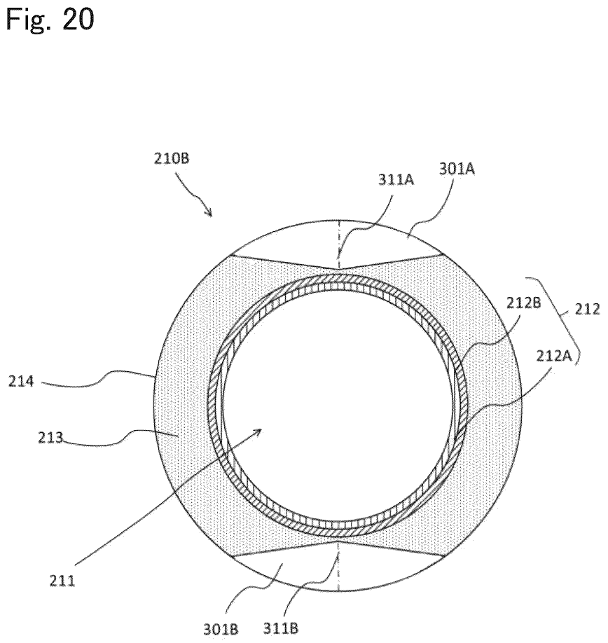

FIG. 19 is a schematic cross-sectional side view showing an aerosol-generating article 200B according to the present modification. FIG. 20 is a cross-sectional view on arrows H-H of FIG. 19. The aerosol-generating article 200B has about the same configuration as the aerosol-generating article 200A of the above-described embodiment and is different from the aerosol-generating article 200A in that third shaped portions 301A and 301B are provided on the downstream end portion 352. When the third shaped portions 301A and 301B are not distinguished from each other, the portions are each referred to as a third shaped portion 301.

FIG. 19 shows a tobacco part 210B in a cross-sectional view, and a paper tube 220A in a side view. The third shaped portion 301 is formed in the downstream end portion 352 of the tobacco part 210B. The third shaped portion 301 is formed by folding a wrapper 214 from a side surface of the tobacco part 210B toward a through hole 211. Therefore, the third shaped portion 301 can inhibit contents of an elastic deformation layer 213, a flavor release layer 212 and the like from shifting toward the paper tube 220A. Particularly, when the aerosol-generating article 200A is housed in a housing 110, the contents of the tobacco part 210B tend to shift downstream, dragged by a heating unit 120 inserted into the through hole 211, and the third shaped portion 301 can hold the contents and inhibit this shifting.

The third shaped portions 301 may have the same shape and number as the second shaped portions 300 except that they are formed in the downstream end portion 352, and the shape and number may be different. In the illustrated example, folds 311A and 311B are formed in the third shaped portions 301A and 301B, respectively, and the shape of the third shaped portion 301 is not particularly limited if the third shaped portion can inhibit the positional shift of the contents of the aerosol-generating article 200B.

In the aerosol-generating article 200B of the present modification, the tobacco part 210B and the paper tube 220A through which a flavor substance released from the tobacco part 210B pass are arranged side by side along a longitudinal direction, and the third shaped portion 301 is formed in an end portion of the tobacco part 210B on a side on which the paper tube 220A is disposed. This can inhibit the contents of the aerosol-generating article 200B from shifting downstream.

It should be noted that, in the aerosol-generating article 200B, a second shaped portion 300 and the third shaped portion 301 are provided on opposite ends of the tobacco part 210B along the longitudinal direction, respectively, and the second shaped portion 300 does not have to be provided in an upstream end portion 351. In this case, a first shaped portion 50 of an aerosol-generating device 100 can be configured to form a second shaped portion 3000 in the upstream end portion 351 when the aerosol-generating article 200B is housed in a receptacle 1A.

### Modification 2-2

In the above-described embodiment, three second shaped portions 300 may be formed in the upstream end portion 351.

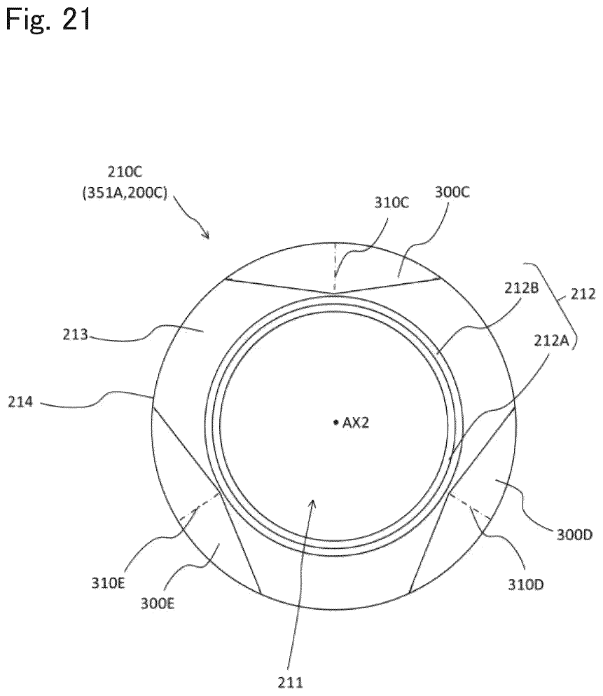

FIG. 21 is a side view schematically showing an upstream end portion 351A of a tobacco part 210C of an aerosol-generating article 10C according to the present modification. In the upstream end portion 351A, three second shaped portions 300C, 300D and 300E are formed symmetrically three times with respect to a second central axis AX2. Folds 310C, 310D and 310E are formed in the second shaped portions 300C, 300D and 300E, respectively, and the second shaped portions 300C, 300D and 300E have a shape that is not particularly limited. The aerosol-generating article 200C according to the present modification is suitable for, but is not limited to, a heater having a circular cross section perpendicular to a longitudinal direction, such as a pin type heater.

### Modification 2-3

In the above-described embodiment, a packaging material constituting the second shaped portion 300 or the third shaped portion 301 may comprise a plurality of layers.

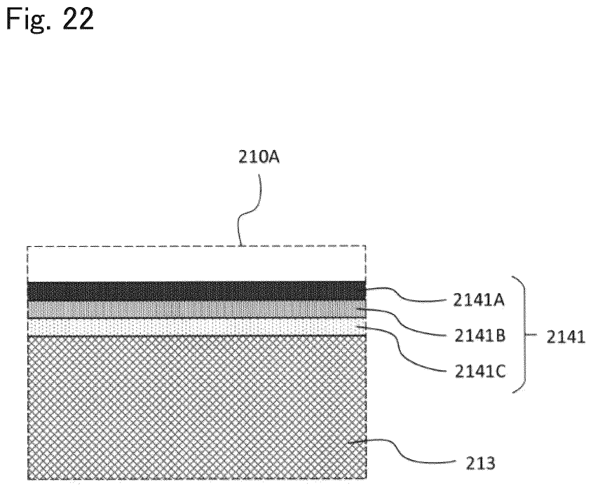

FIG. 22 is a cross-sectional view of a tobacco part 210A showing a wrapper 2141 according to the present modification. The wrapper 2141 is disposed outside an elastic deformation layer 213 and comprises a first layer 2141A, a second layer 2141B and a third layer 2141C. The first layer 2141A, the second layer 2141B and the third layer 2141C are superimposed on one another. Since the wrapper 2141 has a plurality of layers, a packaging material of a plurality of layers firmly holds contents of an aerosol-generating article 200A and can inhibit positional shift of the contents. Also, in manufacturing of the aerosol-generating article 200A, a second shaped portion 300 or a third shaped portion 301 is more easily formed by superimposing sheets on one another while adjusting a thickness rather than by using one thick sheet. In addition, there is no need to prepare sheets with different thicknesses, and efficient manufacturing can be conducted. For example, when forming the second shaped portion 300 by use of a packaging material having a total basis weight of 200 gsm, the second shaped portion 300 can be formed using one sheet having a basis weight of 200 gsm, but the second shaped portion 300 is more easily and preferably formed by using two sheets each of 100 gsm.

As above, the embodiments of the present invention have been described, but the above-described embodiments of the invention are for facilitating understanding of the present invention and do not limit the present invention. The present invention may be modified or improved without departing from its spirit, and the present invention includes equivalents thereto. Furthermore, to such an extent that at least part of the above-described issues can be solved, or to such an extent that at least part of the effects is achieved, respective components described in the claims and the specification can be combined or omitted.

### REFERENCE SIGNS LIST

1A . . . receptacle
1B . . . bottom of receptacle
10, 10A . . . aerosol-generating system
20 . . . shaping guide
30 . . . pressing rib
50, 50A, 50B, 51, 51A, 51B, 52, 52A, 52B, 53, 53A, 53B, 53C . . . first shaped portion
55, 55A, 55B, 551, 551A, 551B, 552, 552A, 552B, 553, 553A, 553B, 553C . . . protruding end portion
100, 100A, 100B, 100C . . . aerosol-generating device
110, 110A . . . housing
111, 111A . . . side wall
112, 112A . . . bottom wall
115 . . . opening
120, 121 . . . heating unit
200, 200A, 200B, 200C . . . aerosol-generating article
210, 210A, 210B, 210C . . . tobacco part
212 . . . flavor release layer
214, 2141 . . . wrapper
215 . . . annular sheet
220, 220A . . . paper tube
250, 351, 351A . . . upstream end portion
300, 300A, 300B, 3000, 3000A, 3000B . . . second shaped portion
301, 301A, 302B . . . third shaped portion
352 . . . downstream end portion
910 . . . control unit
920 . . . power supply unit
1200 . . . heating control system
1201 . . . first main surface
1202 . . . second main surface
2000 . . . housed article
AX1 . . . central axis of receptacle
AX2 . . . central axis of aerosol-generating article
D1 . . . shaped portion distance
W1 . . . heating unit width
H10 . . . first height
W10 . . . first width
H20 . . . second height
W20 . . . second width
θ . . . inclination angle

1. An aerosol-generating system comprising an aerosol-generating device, an aerosol-generating article that generates an aerosol by heating, and a heating unit, the aerosol-generating device comprising:
a receptacle that houses the aerosol-generating article, and
a power supply unit that supplies power to the heating unit, wherein:
the heating unit heats the aerosol-generating article housed in the receptacle;
the aerosol-generating device further comprises a first shaped portion having a protruding first shape formed on a bottom of the receptacle;
the aerosol-generating article comprises an end portion inserted into the receptacle;
the end portion is configured to include a second shaped portion having a second shape corresponding to the first shape, when the aerosol-generating article is housed in the receptacle; and
at least part of a surface of the second shaped portion is inclined with respect to a longitudinal direction of the aerosol-generating article.

2. The aerosol-generating system according to claim 1, wherein the second shaped portion holds contents of the aerosol-generating article so that the contents do not remain in the receptacle, when the aerosol-generating article is taken out of the receptacle.

3. The aerosol-generating system according to claim 1, wherein a packaging material packaging the aerosol-generating article forms the surface of the second shaped portion.

4. The aerosol-generating system according to claim 3, wherein the packaging material has a basis weight of 20 gsm or more and 200 gsm or less, in a portion constituting the second shaped portion.

5. The aerosol-generating system according to claim 3, wherein the second shaped portion comprises a fold of the packaging material toward inside the end portion.

6. The aerosol-generating system according to claim 1, wherein at least part of the surface of the second shaped portion is inclined with respect to a direction to insert the aerosol-generating article into the receptacle so that a tangent plane of the at least part of the surface of the second shaped portion intersects a central axis of the aerosol-generating article on an end face side of the end portion away from the at least part of the surface of the second shaped portion.

7. The aerosol-generating system according to claim 1, wherein a width of the second shape in a certain direction perpendicular to the longitudinal direction of the aerosol-generating article increases as being toward an end face side of the end portion of the aerosol-generating article.

8. The aerosol-generating system according to claim 1, wherein the second shaped portion is disposed on each of opposite sides of the end portion along a direction perpendicular to the longitudinal direction of the aerosol-generating article.

9. The aerosol-generating system according to claim 1, wherein the first shape has an arched shape.

10. The aerosol-generating system according to claim 1, wherein the first shape has a blade shape.

11. The aerosol-generating system according to claim 1, wherein the receptacle comprises a bottom wall intersecting a receptacle central axis that is a central axis of the receptacle, and a side wall extending along the receptacle central axis, and
the first shaped portion is provided in contact with at least one of the bottom wall and the side wall.

12. The aerosol-generating system according to claim 11, wherein a surface of the first shaped portion is inclined with respect to the receptacle central axis.

13. The aerosol-generating system according to claim 12, wherein in a certain vertical cross section including the receptacle central axis, an angle formed by the surface of the first shaped portion and the receptacle central axis is 30° or more and 60° or less.

14. The aerosol-generating system according to claim 11, wherein the first shape includes a sharp shape extending along a radial direction with respect to the receptacle central axis and tapering toward the receptacle central axis.

15. The aerosol-generating system according to claim 11, wherein a width of the first shape in a direction perpendicular to the receptacle central axis gradually decreases or increases along the receptacle central axis.

16. The aerosol-generating system according to claim 11, wherein the receptacle includes a plurality of first shaped portions provided at different circumferential positions with respect to the receptacle central axis.

17. The aerosol-generating system according to claim 1, wherein the receptacle comprises the heating unit, or a metal body housed in the receptacle together with the aerosol-generating article constitutes a heating element of the heating unit.

18. The aerosol-generating system according to claim 1, wherein the end portion of the aerosol-generating article does not comprise the second shaped portion, and the end portion and the first shaped portion are configured such that the end portion is pressed by the first shaped portion to form the second shaped portion, when the aerosol-generating article is inserted into the receptacle.

19. The aerosol-generating system according to claim 1, wherein the first shape includes a convex portion, and the second shape includes a concave portion.

20. The aerosol-generating system according to claim 1, wherein the aerosol-generating device is a flavor inhaler that generates an aerosol having a flavor, and the aerosol-generating article is a tobacco stick.
